(19) United States
(12) Patent Application Publication
(10) Pub. No.: US 2013/0231992 A1
(43) Pub. Date: Sep. 5, 2013

(54) COMMODITY RECOGNITION APPARATUS AND COMMODITY RECOGNITION METHOD

(71) Applicant: TOSHIBA TEC KABUSHIKI KAISHA, Tokyo (JP)

(72) Inventors: Hiroshi Sugasawa, Miyagi-ken (JP); Hidehiro Naito, Shizuoka-ken (JP); Hitoshi Iizaka, Shizuoka-ken (JP)

(73) Assignee: TOSHIBA TEC KABUSHIKI KAISHA, Tokyo (JP)

(21) Appl. No.: 13/780,187

(22) Filed: Feb. 28, 2013

(30) Foreign Application Priority Data
Mar. 5, 2012 (JP) 2012-047826
Dec. 19, 2012 (JP) 2012-277161

(51) Int. Cl. G06Q 30/02

(52) U.S. Cl. CPC G06Q 30/0207
USPC 705/14.26

(57) ABSTRACT

An apparatus recognizes an object from an image picked-up by an image pickup unit. The apparatus recognizes whether the object recognized by the image recognition unit is a commodity or a coupon. The apparatus outputs, if a commodity recognized by the object recognition unit is the object to which a coupon recognized by the object recognition unit, the information relative to the commodity and the information relative to the coupon applied to the commodity.

### CROSS-REFERENCE TO RELATED APPLICATION

The present application is based upon and claims the benefit of priorities from Japanese Patent Application No. 2012-047826 filed on Mar. 5, 2012 and Japanese Patent Application No. 2012-277161 filed on Dec. 19, 2012, the entire contents of which are hereby incorporated by reference.

### FIELD

Embodiments described herein relate to a commodity recognition apparatus using an image pickup unit and a commodity recognition method for enabling a computer to function as the commodity recognition apparatus.

### BACKGROUND

A commodity recognition apparatus is known which recognizes a code symbol adhered on a commodity from an image shot by an image pickup unit. A technology is known according to which when a code symbol, a discount voucher or a preferential treatment voucher adhered on a commodity is recognized from a shot image by such a commodity recognition apparatus, the information relative to the commodity and the information relative to the coupon are output to a POS (Point Of Sales) terminal.

### BRIEF DESCRIPTION OF THE DRAWINGS

FIG. 1 is a functional block diagram of a self-service POS terminal according to embodiment 1.

FIG. 2 is an external oblique view of the self-service POS terminal according to embodiment 1.

FIG. 3 is a block diagram showing the hardware configuration of the self-service POS terminal according to embodiment 1.

FIG. 4 is a pattern diagram showing the data structure of a commodity data record stored in a commodity database according to embodiment 1.

FIG. 5 is a pattern diagram showing the data structure of a coupon data record stored in a coupon database according to embodiment 1.

FIG. 6 is a pattern diagram showing the data structure of an image data record stored in an image database according to embodiment 1.

FIG. 7 is a pattern diagram showing the data structure of a coupon information file stored in a coupon holding memory according to embodiment 1.

FIG. 8 is a flowchart of an information processing procedure carried out by the CPU of the self-service POS terminal in accordance with a reading processing program according to embodiment 1.

FIG. 9 is a flowchart showing, in detail, a coupon reading process involved in the information processing procedure shown in FIG. 8.

FIG. 10 is a flowchart showing, in detail, a commodity reading processing involved in the information processing procedure shown in FIG. 8.

FIG. 11 is a diagram showing an example of the display screen of a display for operator on which a reading window is blocked by a purchased commodity ‘apple’ according to embodiment 1.

FIG. 12 is a diagram showing an example of the screen shown in FIG. 11 on which a commodity ‘apple produced in AA’ is selected.

FIG. 13 is a diagram showing an example of the display screen of a display for operator on which a reading window is blocked by a coupon ‘apple: 10% off’ according to embodiment 1.

FIG. 14 is a diagram showing an example of the screen shown in FIG. 13 on which a coupon ‘apple: 10% off’ is selected.

FIG. 15 is a diagram showing an example of the screen shown in FIG. 14 on which a reading window is blocked by a purchased commodity ‘apple’ after a coupon ‘apple: 10% off’ is selected.

FIG. 16 is a diagram showing an example of the screen shown in FIG. 15 on which a purchased commodity ‘apple’ is the object to which a coupon ‘apple: 10% off’ is applied.

FIG. 17 is a diagram showing an example of a screen transferred from the screen shown in FIG. 16.

FIG. 18 is a diagram showing an example of a notification screen on which a coupon ‘apple: 10% off’ is not used is shown according to embodiment 1.

FIG. 19 is a functional block diagram of a self-service POS terminal according to embodiment 2.

FIG. 20 is a pattern diagram showing a coupon information file stored in a coupon holding memory according to embodiment 2.

FIG. 21 is a flowchart of a commodity reading processing carried out by the CPU of the self-service POS terminal in accordance with a reading processing program according to embodiment 2.

FIG. 22 is a diagram showing an example of a screen on which a reading window is blocked by a purchased commodity ‘apple’ according to embodiment 2.

FIG. 23 is a diagram showing an example of the screen shown in FIG. 22 on which a coupon ‘apple: 10% off’ is selected.

FIG. 24 is a pattern diagram showing a commodity information file stored in a commodity holding memory according to embodiment 3.

FIG. 25 is a flowchart of an information processing procedure carried out by the CPU of the self-service POS terminal in accordance with a reading processing program according to embodiment 3.

FIG. 26 is a flowchart showing, in detail, a commodity reading processing involved in the information processing procedure shown in FIG. 25.

FIG. 27 is a flowchart showing, in detail, a coupon reading process involved in the information processing procedure shown in FIG. 25.

FIG. 28 is a flowchart of an information processing procedure carried out by the CPU of a self-service POS terminal in accordance with a reading processing program according to embodiment 4.

FIG. 29 is a flowchart showing, in detail, a collation process involved in the information processing procedure shown in FIG. 28.

FIG. 30 is a flowchart showing, in detail, a collation process according to embodiment 5.

### DETAILED DESCRIPTION

In accordance with an embodiment, a commodity recognition apparatus comprises an image recognition unit, an object recognition unit and an information output unit. The image recognition unit recognizes an object from an image picked-up by an image pickup unit. The object recognition unit recognizes whether the object recognized by the image recognition unit is a commodity or a coupon. The information output unit outputs, if a commodity recognized by the object recognition unit is the object to which a coupon recognized by the object recognition unit, the information relative to the commodity and the information relative to the coupon applied to the commodity.

Embodiments of the commodity recognition apparatus are described below with reference to accompanying drawings. Additionally, the embodiments are applied to the commodity recognition unit of a self-service POS terminal.

### Embodiment 1

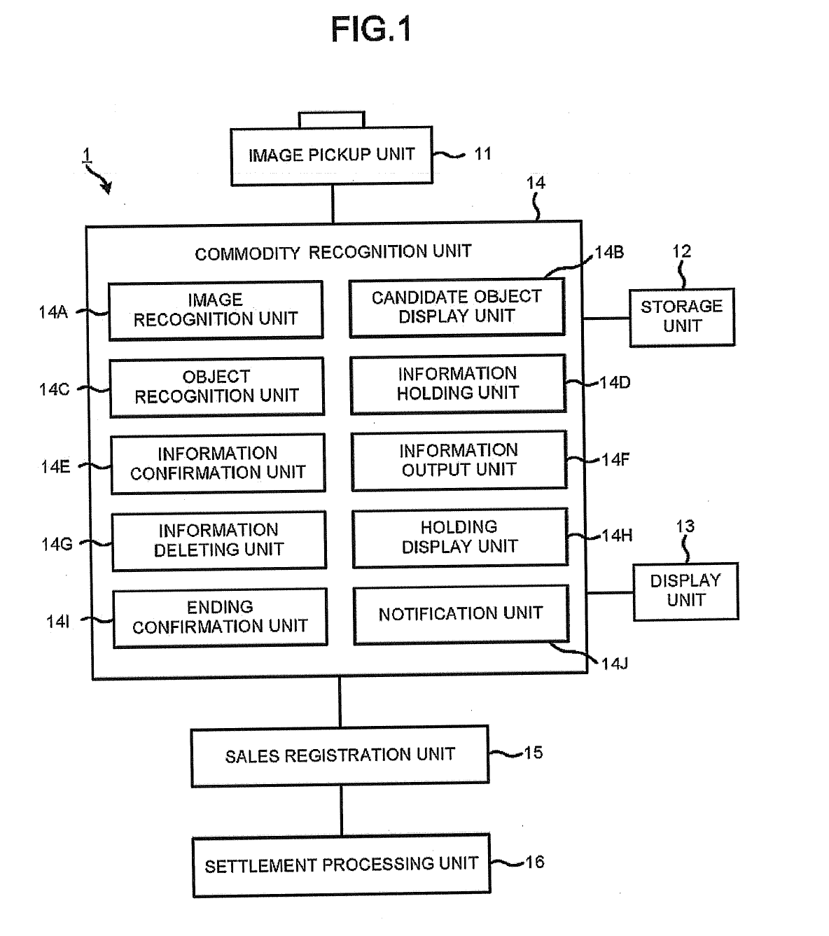

FIG. 1 is a functional block diagram of a self-service POS terminal 1 according to embodiment 1. As shown in FIG. 1, the self-service POS terminal 1 comprises: an image pickup unit 11 functions as an image pickup unit; a storage unit 12; a display unit 13; a commodity recognition unit 14 configured to read a commodity from an image shot by the image pickup unit 11; a sales registration unit 15 configured to register the sales data of the commodity read by the commodity recognition unit 14; and a settlement processing unit 16 configured to realize the checkout of a commodity transaction based on the commodity sales data registered by the sales registration unit 15.

The commodity recognition unit 14 can function as an image recognition unit 14A, a candidate object display unit 14B, an object recognition unit 14C, an information holding unit 14D, an information confirmation unit 14E, an information output unit 14F, an information deleting unit 14G, a holding display unit 14H, an ending confirmation unit 14I and an unused coupon notification unit 14J.

The image recognition unit 14A recognizes an object from an image shot by the image pickup unit 11. The candidate object display unit 14B extracts candidate objects similar to the object recognized by the image recognition unit 14A from a group of objects registered in advance, and displays the candidate objects on the display unit 13 in a selectable manner. The object recognition unit 14C recognizes whether an object selected from the candidate objects displayed on the display unit 13 is a commodity or a coupon. If the object recognized by the object recognition unit 14C is a coupon, the information holding unit 14D stores the information relative to the coupon in the storage unit 12 (coupon information holding unit). If the object recognized by the object recognition unit 14C is a commodity, the information confirmation unit 14E confirms whether or not information relative to a coupon applied to the commodity is stored in the storage unit 12 (coupon information confirmation unit) If the information confirmation unit 14E confirms that information relative to a coupon applied to the commodity is not stored in the storage unit 12, the information output unit 14F only outputs information relative to the commodity to the sales registration unit 15, and if the information confirmation unit 14E confirms that information relative to a coupon applied to the commodity is stored in the storage unit 12, the information output unit 14F outputs information relative to the commodity and the information relative to the coupon to the sales registration unit 15. The information deleting unit 14G deletes, if the information output unit 14F outputs the information relative to the coupon, the information relative to the coupon from the storage unit 12 (coupon information deleting unit). The holding display unit 14H activates, during the period in which information relative to a coupon is stored in the storage unit 12, the display unit 13 to display the image of the coupon relative to the information (holding coupon display unit). The ending confirmation unit 14I confirms whether or not the commodities settled in one transaction are all read. The unused coupon notification unit 14J notifies, if the ending confirmation unit 14I confirms the end of a reading process while information relative to a coupon is stored in the storage unit 12, that the coupon relative to the information is not used.

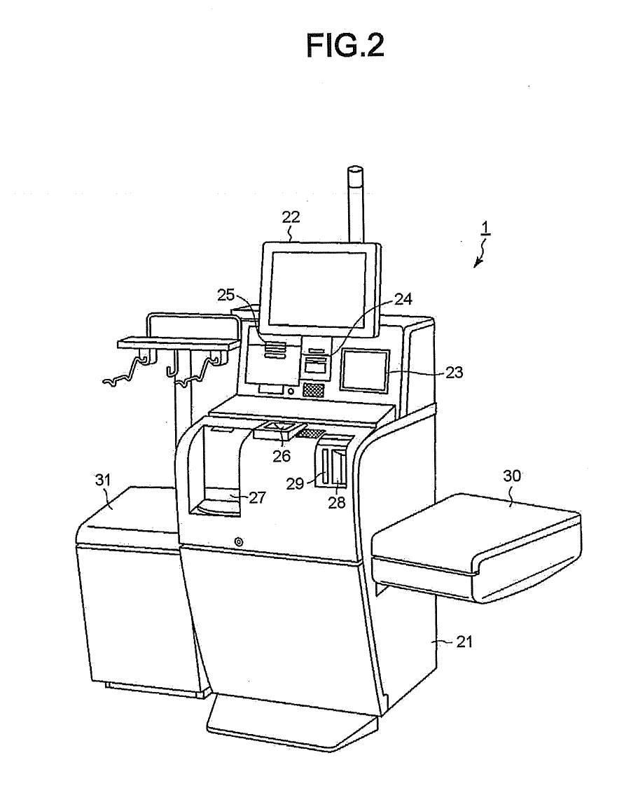

FIG. 2 is an external oblique view of the self-service POS terminal 1. As shown in FIG. 2, a display 22 for operator, the reading window 23 of the image pickup unit 11, a reader-writer 24 and a receipt issuing port 25 are configured on the front upper portion of the main body 21 of the self-service POS terminal 1. Further, a coin depositing port 26, a coin dispensing port 27, a bill depositing port 28 and a bill dispensing port 29 are formed in the center of the front side of the main body 21. Further, a commodity placing table 30 for holding an unsettled commodity is configured on one side of the main body 2, and a commodity placing table 31 for holding a settled commodity is configured on the other side of the main body 2.

The display 22 for operator is a display which is provided with a touch panel which is touched to input information. Moreover, an image shot by the image pickup unit 11 and images of objects extracted as candidate objects are displayed on the display 22 for operator. That is, the display 22 for operator functions as the display unit 13. A registration screen on which the commodity name, the unit price, the sales volume and the sales amount of the commodity registered by the sales registration unit 15 and a checkout screen on which the total amount of and the change amount for a commodity transaction settled by the settlement processing unit 16 are displayed on the display 22 for operator.

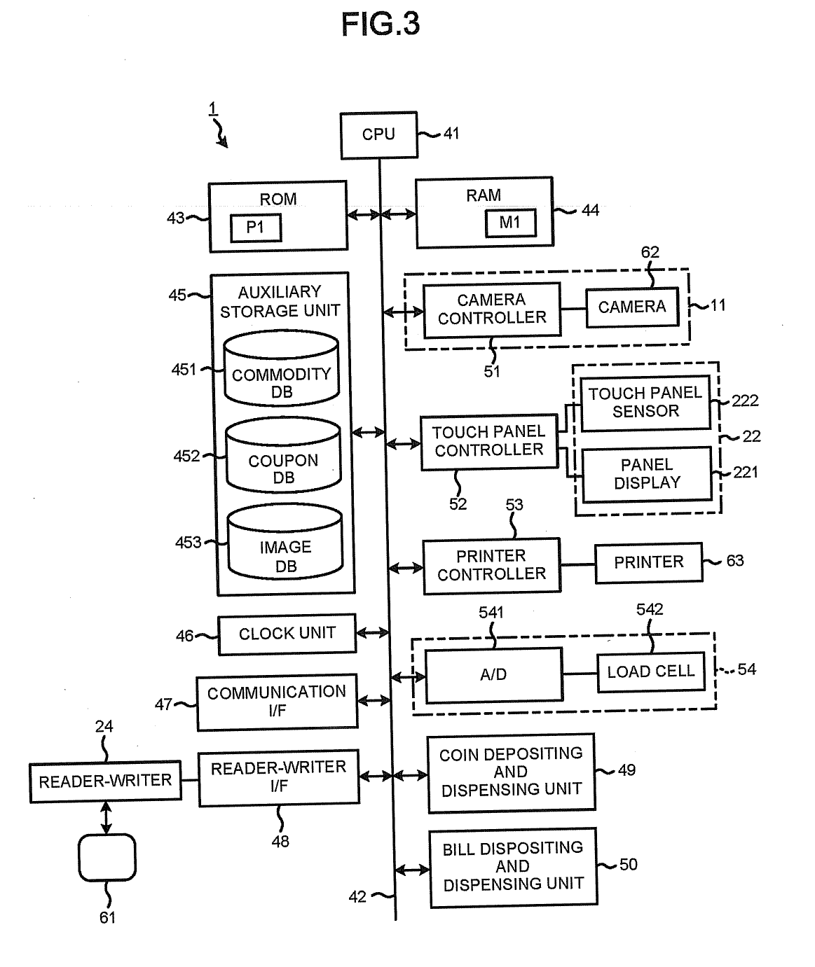

The reader-writer 24 writes/reads data into/from a card medium 61 (refer to FIG. 3) such as an electronic money card and a point card. The receipt issuing port is an issue port for issuing a receipt that is printed by a printer 63 (refer to FIG. 3) configured in the main body 21 if a checkout processing is ended. The coil depositing port 26 is an input port for inputting coins for a settlement. The coin dispensing port 27 is a return port for returning coins as change. The bill depositing port 28 is an input port for inputting bill for a settlement. The coin dispensing port 29 is a return port for returning bill as change.

FIG. 3 is a block diagram showing the hardware configuration of the self-service POS terminal 1. As shown in FIG. 3, in the self-service POS terminal 1, a CPU (Central Processing Unit) 41 is configured as the main body of a control unit. Then, the CPU 41 is connected with an ROM (Read Only Memory) 43, an RAM (Random Access Memory) 44, an auxiliary storage unit 45, a clock unit 46, a communication interface 47, a reader-writer interface 48, a coin depositing and dispensing unit 49, a bill depositing and dispensing unit 50, a camera controller 51, a touch panel controller 52, a printer controller 53 and the A/D (analog-to-digital) converter of a weighing unit 54 through a bus line such as an address bus line and a data bus line.

The clock unit 46 times the current date and time. The communication interface 47 takes charge of the data communication between a store server and an attendant terminal that are connected with each other via a network. The reader-writer interface 48 reads the data in the card medium 61 read by the reader-writer 24. The reader-writer interface 48 outputs the data that should be written into the card medium 61 to the reader-writer 24.

The coin depositing and dispensing unit 49 counts the coins input from the coin depositing port 26 by denomination to calculate the amount of the input coins and accommodates the input coins in a cash box (not shown) by denomination. Moreover, the coin depositing and dispensing unit 49 takes the coins needed for a change making out from the cash box according to a change output instruction of the CPU 41 and outputs the coins to the coin dispensing port 27. The bill depositing and dispensing unit 50 counts the bill input from the bill depositing port 28 by the denomination to calculate the amount of the input bill and accommodates the input bill in a cash box (not shown) by denomination. The bill depositing and dispensing unit 50 takes the bill needed for a change making out from the cash box according to a change output instruction of the CPU 41 and outputs the bill to the bill dispensing port 29.

The camera controller 51 controls the image pickup action of the camera 62. The camera 62, which is configured nearby the internal side of the reading window 23 in the main body 21, comprises: a CCD (Charge Coupled Device) imaging element serving as an area image sensor and the drive circuit thereof and a image pickup lens for imaging the image of a image pickup area S in the CCD image pickup element. The image pickup area S refers to the area of the frame images that are imaged in the area of the CCD image pickup element by the image pickup lens from the reading window 23. The camera 62 outputs the image imaged by the image pickup lens in the image pickup area S in the CCD image pickup element to the camera controller 51. Herein, the camera 62 and the camera controller 51 constitute the image pickup unit 11.

The touch panel controller 52 controls a panel display 221 and a touch panel sensor 222 which constitute the display 22 for operator. The panel display 221 may be, for example, a liquid crystal display. The touch panel sensor 222 is overlapped on the screen of the panel display 221. The touch panel controller 52 activates the panel display 221 to display an image and monitors the detection signal of the touch panel sensor 222 and, if a detection signal is input, recognizes the image data of a touched area according to the signal.

The printer controller 53 controls the printer 63 for printing a receipt. The weighing unit 54 includes a load cell 542 configured on the commodity placing table 32 and an A/D converter 541 for converting an analog weight signal output from the load cell 542 into a digital weight data.

The auxiliary storage unit 45, for example consisting of an HDD (Hard Disk Drive) and an SSD (Solid State Drive) at least comprises a commodity database 451, a coupon database 452 and an image database 453.

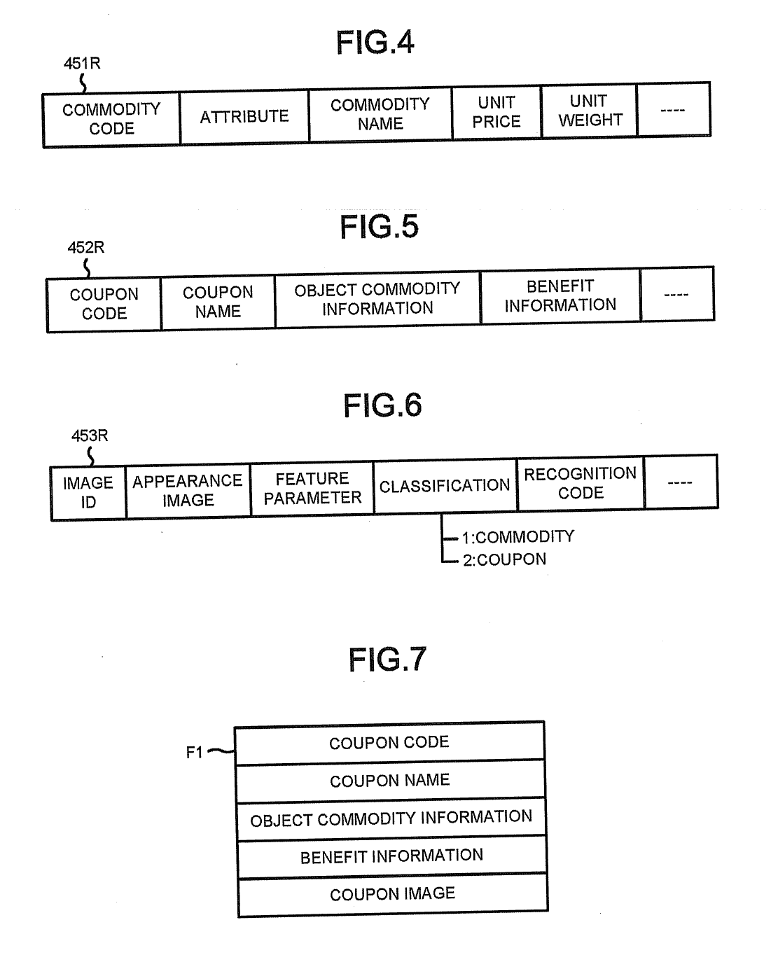

As shown in FIG. 4, a commodity data record 451R, in which a commodity code fixedly set for a commodity sold in a store is stored in association with commodity data including the attribute, the commodity name, the unit price and the unit weight of the commodity designated by the commodity code, is recorded in the commodity database 451. The attribute is information designating the category (e.g. vegetable, fruit, meat, fish, processed food, sweet stuff, beverage) of a commodity designated by a corresponding commodity code. The unit weight refers to the average weight of each commodity designated by a corresponding commodity code, the CPU 41 compares the unit weight of a commodity registered by the sales registration unit 15 with the weight measured by the weighing unit 54 to determine whether or not the registered commodity is placed on the commodity placing table 32 correctly.

As shown in FIG. 5, a coupon data record 452R, in which a coupon code that is fixedly preset for a coupon (e.g. discount voucher, preferential treatment voucher, commodity voucher and cash voucher) usable in a store is stored in association with coupon data including the coupon name, object commodity information and benefit information of the coupon designated by the coupon code, is stored in the coupon database 452. The object commodity information refers to information designating a commodity to be an object to which a coupon designated by a corresponding coupon code is applied, for example, commodity code and the attribute is set. For example, in the case that it is a coupon for unspecified commodities such as ‘10% off’ regardless of the category of commodity, the data indicating for unspecified commodities such as ‘00’ is set as the object commodity information.

The benefit information is the content of a benefit (e.g. 10% off, or 10 Yen off) offered to a customer by a coupon designated by a corresponding coupon code.

As shown in FIG. 6, an image data record 453R, in which a unique image ID is stored in association with appearance image data, appearance feature parameters, an object classification and a recognition code, is recorded in the image database 453. The appearance image data is data representing appearance images of a commodity designated by a commodity data record 451R stored in the commodity database 451 and a coupon designated by a coupon data record 452R stored in the coupon database 452. The appearance feature parameters are parameters obtained by turning appearance feature values, such as shape, surface tint, pattern, and concave-convex state, of an object (commodity or coupon) acquired from an appearance image marked with a corresponding image ID to numerical values. The object classification is information for recognizing whether an object the appearance image of which is marked with a corresponding image ID is a commodity or a coupon. In the embodiment, the classification information for recognizing a commodity is set to be “1”, and the classification information for recognizing a coupon is set to be “2”. The recognition code, which is a code designating an object the appearance image of which is marked with a corresponding image ID, is set to be a commodity code if the object is a commodity or a coupon code if the object is a coupon.

Various memory areas for storing variable data temporarily are formed in the RAM 44. Specifically, in the embodiment, a coupon holding memory M1 is formed in the RAM 44. As shown in FIG. 7, a coupon holding memory M1 is an area for storing a coupon information file 1 containing a coupon code, a coupon name, object commodity information, benefit information and appearance image data of a coupon.

The ROM 43 is an area for storing fixed data such as a program. In the embodiment, at least a reading processing program P1 is stored in the ROM 43. The program P1 enables the CPU 41 of a computer to function as the image recognition unit 14A, the candidate object display unit 14B, the object recognition unit 14C, the information holding unit 14D, the information confirmation unit 14E, the information output unit 14F, the information deleting unit 14G, the holding display unit 14H, the ending confirmation unit 14I and the unused coupon notification unit 14J of the commodity recognition unit 14.

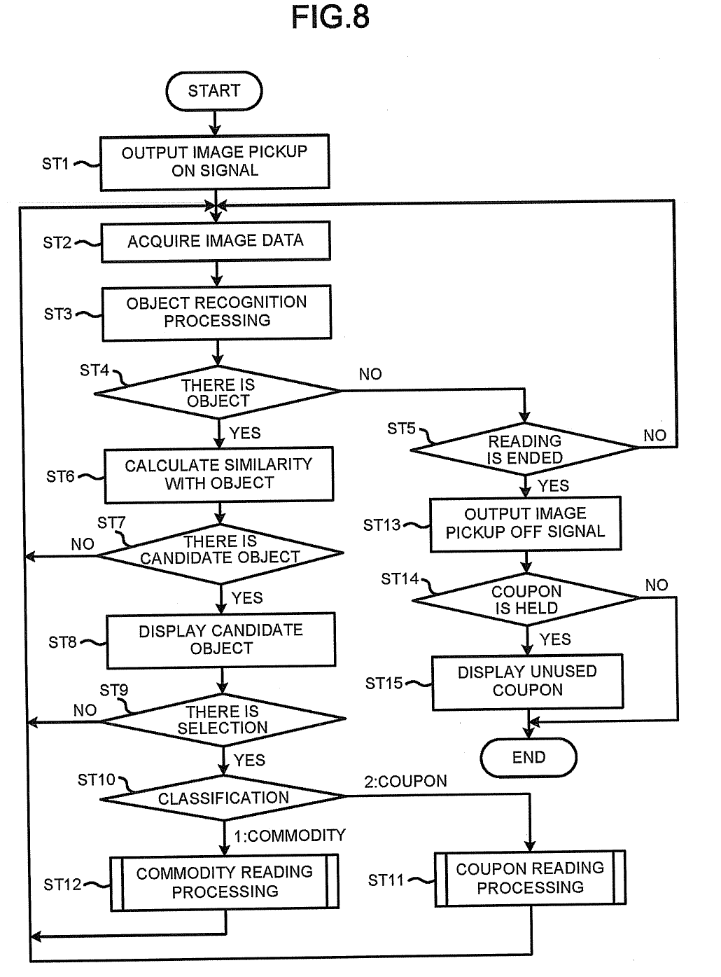

FIG. 8-FIG. 10 are flowcharts showing an information processing procedure carried out by the CPU 41 in accordance with the reading processing program P1. Functions of the image recognition unit 14A, the candidate object display unit 14B, the object recognition unit 14C, the information holding unit 14D, the information confirmation unit 14E, the information output unit 14F, the information deleting unit 14G, the holding display unit 14H, the ending confirmation unit 14I and the unused coupon notification unit 14J are illustrated based on the flowcharts.

The information processing illustrated by the procedures shown in the flowchart of FIG. 8 is started when, for example, a start button displayed on the display 22 for operator is touched. If the information processing is started, first, the CPU 41 outputs an image pickup on signal to the camera controller 51 (ST1). The camera 62 starts to shoot an image pickup area based on the image pickup on signal. The frame images of the image pickup area shot by the camera 62 are sequentially stored in the RAM 44.

The CPU 41 acquires data of the frame images stored in the RAM 44 (ST2). Then, the CPU 41 recognizes the object contained in the frame images (ST3: image recognition unit 14A). Specifically, the CPU 41 first extracts a contour line from an image resulting from the binarization of the frame images. In this way, the CPU 41 attempts to extract the contour of the object reflected in the frame images. If the contour of an object is extracted, the CPU 41 reads the feature values, such as the shape, the surface tint, the pattern and the concave-convex state, of the commodity from the image in the contour.

The recognition of an object contained in such an image is referred to as generic object recognition, which is carried out by various recognition methods that are respectively illustrated in the following documents:

YANAI Keiji, ‘The current state and further directions on Generic Object Recognition’, in Proceedings of Information Processing Society of Japan, Vol. 48, No. SIG 16, In URL:http://mm.cs.uec.ac.jp/IPSJ-TCVIM-Yanai.pdf [retrieved on Aug. 10, 2010].

The technology for recognizing an ordinary object through image segmentation for each object is described in the following document:

Jamie Shotton: ‘Semantic Texton Forests for Image Categorization and Segmentation’, In URL:http://citeseerx.ist.psu.edu/viewdoc/download?doi=10.1.1.145.3036&rep=repl&type=pdf (retrieved on Aug. 10, 2010).

The CPU 41 confirms whether or not an object can be recognized from the image (ST4). If no object is recognized (ST4: NO), the CPU 41 confirms whether or not there is a announcement on the end of a reading process (ST5: ending confirmation unit 14I). The end of the reading processing is notified when, for example, a checkout button on the display 22 for operator is touched. If there is no announcement on the end of the reading process (ST5: NO), the CPU 41 returns to ACT ST2 to acquire next image data to attempt to recognize an object.

If an object is recognized (ST4: YES), the CPU 41 checks up the feature value data of the object with the appearance feature parameters of the objects stored in the image database 453 to calculate the similarity between each appearance feature parameter and the feature value data (ST6). The greater the similarity is, the more possible that the objection designated by the recognition code contained in an image data record 453R set using the appearance feature parameter is recognized from an image in ACT ST3.

The CPU 41 confirms whether or not there is an appearance feature parameter the similarity of which with feature value data is greater than a predetermined threshold value, that is, confirms whether or not there is a candidate object which may be a candidate for the object recognized from the image (ST7). If there is no candidate object (ST7: NO), the CPU 41 returns to ACT ST2 to acquire next image data to attempt to recognize an object.

If there is only one candidate object (ST7: YES), the CPU 41 extracts image data of the candidate object, that is, extracts appearance image data of an image data record 453R in which an appearance feature parameter the similarity of which with the feature value data of the object recognized from the shot image is greater than or equal to the predetermined threshold is set. Then, the CPU 41 activates the display 22 for operator to display the image of the extracted candidate object. At this time, the image of the candidate object is displayed as a touch switch in a selectable manner (ST8: candidate object display unit 14B).

The CPU 41 confirms whether or not one of the candidate objects is selected (ST9). For example, a touch switch announcing ‘no matched object’ is displayed on the screen on which the image of a candidate object is displayed, the CPU 41 records that there is no object selected if the touch switch is input.

If there is no object selected (ST9: NO), the CPU 41 returns to ACT ST2 to acquire next image data to attempt to recognize an object.

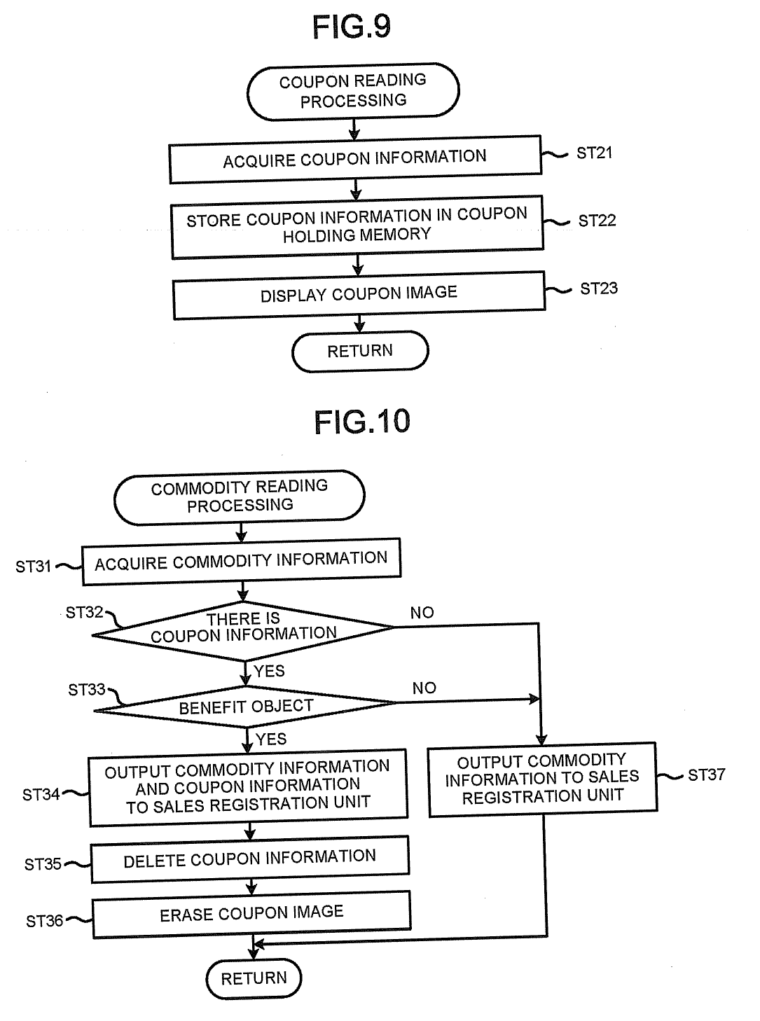

If it is confirmed based on a signal from the touch panel sensor 222 that one of the candidate objects is selected (ST9: YES), then the CPU 41 checks up on the object classification of the selected object the image data of which is set in the image data record 453R (ST10: object recognition unit 14C). Here, if the object classification is ‘2’, that is, the selected object is a coupon, the CPU 41 executes the coupon reading processing illustrated by the ACTs specifically shown in the flowchart of FIG. 9 (ST11).

That is, the CPU 41 detects the recognition code of an image data record 453R containing the image data of the selected object as a coupon code. Then, the CPU 41 retrieves the coupon database 452 using the coupon code to acquire, from the coupon data record 452R containing the coupon code, a coupon code, a coupon name, object commodity information and benefit information (ST21).

After acquiring the coupon information, the CPU 41 creates a coupon information file F1 using the coupon information and the image data of the coupon. Then, the CPU 41 stores the coupon information file F1 in the coupon holding memory M1 (ST22: information holding unit 14D). Moreover, the CPU 41 activates the display 22 for operator to display the image of the coupon (ST23: holding display unit 14H). Thereafter, the CPU 41 returns to ACT ST2 to acquire next image data to attempt to recognize an object.

On the other hand, if the object classification is ‘1’, that is, the selected object is a commodity, in ACT ST 10, the CPU 41 executes the commodity reading processing illustrated by the ACTs specifically shown in the flowchart of FIG. 10 (ST12).

That is, the CPU 41 detects the recognition code of an image data record 453R containing the image data of the selected object as a commodity code. Then, the CPU 41 retrieves the commodity database 451 using the commodity code to acquire, from a commodity data record 451 containing the commodity code, commodity information including a commodity code, an attribute, a commodity name, a unit price and a unit weight (ST31).

If the CPU 41 acquires the commodity information, then the CPU 41 confirms whether or not a coupon information file F1 is stored in the coupon holding memory M1, that is, confirms whether or not there is coupon information stored (ST32: information confirmation unit 14E). If there is coupon information stored in the coupon holding memory M1 (ST32: YES), the CPU 41 reads object commodity information from the coupon information and checks up the read object commodity information with the commodity code and attribute contained in the commodity information acquired to confirm whether or not the commodity corresponding to the commodity information is the benefit object of the coupon corresponding to the coupon information stored in the coupon holding memory M1 (ST33: information confirmation unit 14E).

If the commodity corresponding to the commodity information is the coupon benefit object (ST33: YES), the CPU 41 outputs the acquired commodity information and the coupon information stored in the coupon holding memory M1 to the sales registration unit 15 (ST34: information output unit 14F). Then, the CPU 41 erases the coupon information file F1 from the coupon holding memory M1 (ST35: information deleting unit 14G). Moreover, the CPU 41 deletes the image of the coupon from the display 22 for operator (ST36). Sequentially, the CPU 41 returns to ACT ST2 to acquire next image data to attempt to recognize an object.

On the other hand, if there is no coupon information stored in the coupon holding memory M1 (ST32: NO), or although there is coupon information stored in the coupon holding memory M1, the commodity corresponding to the acquired commodity information is not the benefit object of a coupon corresponding to the coupon information (ST33: NO), the CPU 41 only outputs the acquired commodity information to the sales registration unit 15 (ST37: information output unit 14F). Then, the CPU 41 returns to ACT ST2 to acquire next image data to attempt to recognize an object.

In this way, the CPU 41 repeats the processing of ACTs ST6-ST12 every time an object is recognized through the object recognition processing described in ACT ST3 (ST4: YES). Then, if there is an announcement on the end of the reading process (ST5: YES), the CPU 41 outputs a image pickup off signal to the camera controller 51 (ST13). The camera 62 stops shooting based on the image pickup off signal.

After outputting the image pickup off signal, the CPU 41 confirms whether or not coupon information is stored in the coupon holding memory M1 (ST14). If no coupon information is stored in the coupon holding memory M1 (ST14: NO), the processing is ended.

On the contrary, if there is coupon information stored in the coupon holding memory M1 (ST14: YES), the CPU 41 activates the display 22 for operator to notify the user of a message ‘there is an unused coupon’ (ST15: unused coupon notification unit 14J), then the processing is ended.

The customer using the self-service POS terminal 1 having a related configuration first touches the start button. Next, the customer holds the commodities purchased one after another over the reading window 23. If the customer has the coupon for the purchased commodity, first holds the coupon over the reading window 23 and then holds the purchased commodity that the coupon is available over the reading window 23.

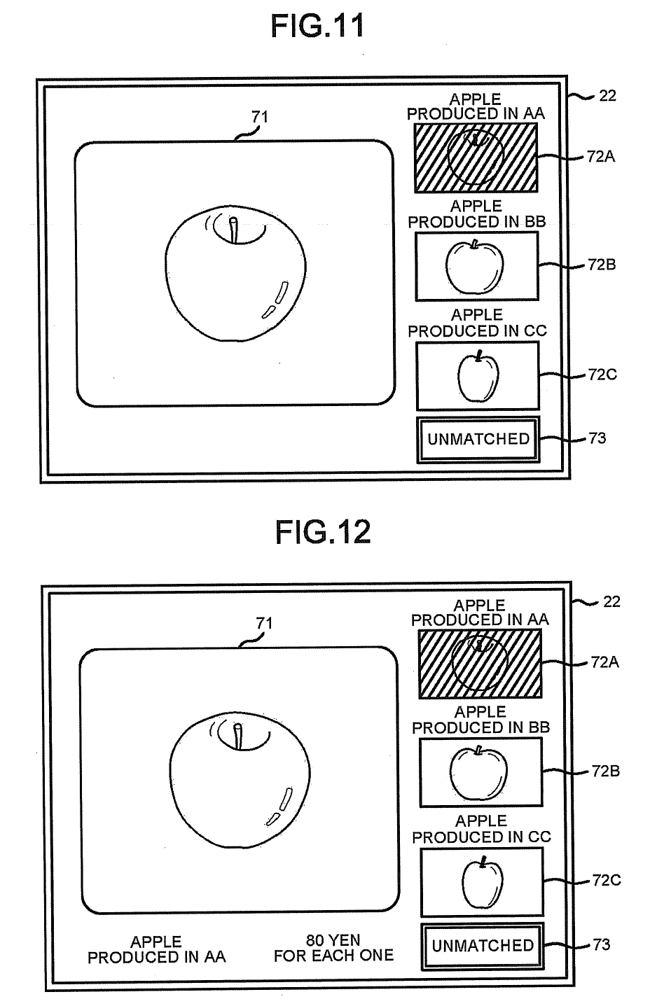

FIG. 11 and FIG. 12 show examples of the display screen of the display 22 for operator on which the purchased commodity ‘apple’ is not the object of a coupon. If the customer holds the purchased commodity ‘apple’ over the reading window 23, as shown in FIG. 11, the image of the commodity ‘apple’ shot by the camera 62 is displayed in a shot image display area 71 in the center of the screen of the display 22 for operator.

At this time, if the image recognition unit 14A recognizes the commodity ‘apple’ in the shot image as an object, candidate objects (‘apple produced in AA’, ‘apple produced in BB’ and ‘apple produced in CC’ in FIG. 11) having an appearance feature parameter having a high similarity with the feature value data of the commodity ‘apple’ are extracted by the candidate object display unit 14B. Then, images of the candidate objects are displayed in a candidate object display area 72 on the right side of the screen as touch switches 72A, 72B and 72C. Moreover, an unmatched button 73 is also displayed on the display 22 for operator as a touch switch for announcing the absence of a matched object in the candidate objects.

If the purchased commodity is the commodity ‘apple produced in AA’ display on the touch switch 72A, then, as shown by the hatching in FIG. 12, the customer touches the touch switch 72A. In this manner, the commodity information of the commodity ‘apple produced in AA’ selected through a touch operation is separately output to the sales registration unit 15 through the object recognition unit 14C, the information confirmation unit 14E and the information output unit 14F. As a result, the sales data of the commodity ‘apple produced in AA’ is registered at a fixed price in the sales registration unit 15. The commodity name, the sales volume and the selling price of the commodity ‘apple produced in AA’ are displayed on the lower part of the screen of the display 22 for operator.

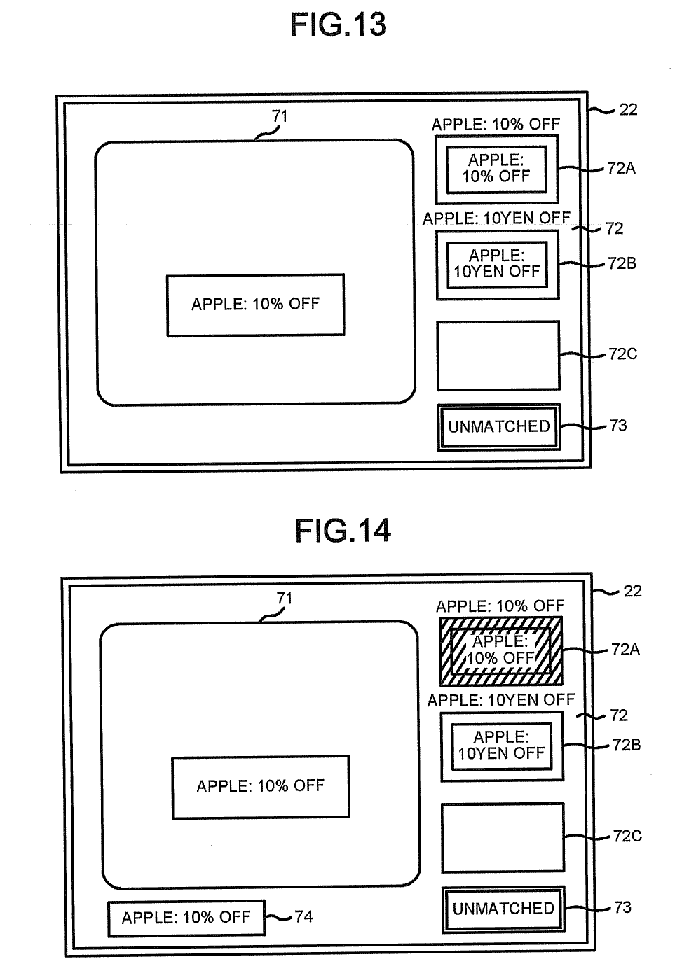

FIG. 13 to FIG. 17 show examples of a display screen of the display 22 for operator in the case where a coupon ‘apple: 10% off’ for a purchased commodity ‘apple’ is used. The customer first holds a coupon ‘apple: 10% off’ over the reading window 23. Sequentially, as shown in FIG. 13, the image of the coupon ‘apple: 10% off’ shot by the camera 62 is displayed in the shot image display area 71.

At this time, if the image recognition unit 14A recognizes the coupon ‘apple: 10% off’ contained in the shot image as an object, candidate objects (in FIG. 13, ‘apple: 10% off’ and ‘apple: 10 Yen off) having an appearance feature parameter extremely similar to the feature value data of the coupon ‘apple: 10% off’ are extracted using the candidate object display unit 14B. Then, images of the candidate objects are displayed in the candidate object display area 72 as touch switches 72A and 72B.

Here, if the coupon ‘apple: 10% off’ display on the touch switch 72A is a used coupon, then, as shown by the hatching in FIG. 14, the customer touches the touch switch 72A. In this way, the coupon information of the coupon ‘apple: 10% off’ is stored in the coupon holding memory M1 through the object recognition unit 14C and the information holding unit 14D. The image 74 of the coupon ‘apple: 10% off’ is displayed on the lower part of the screen of the display 22 for operator through the holding display unit 14H.

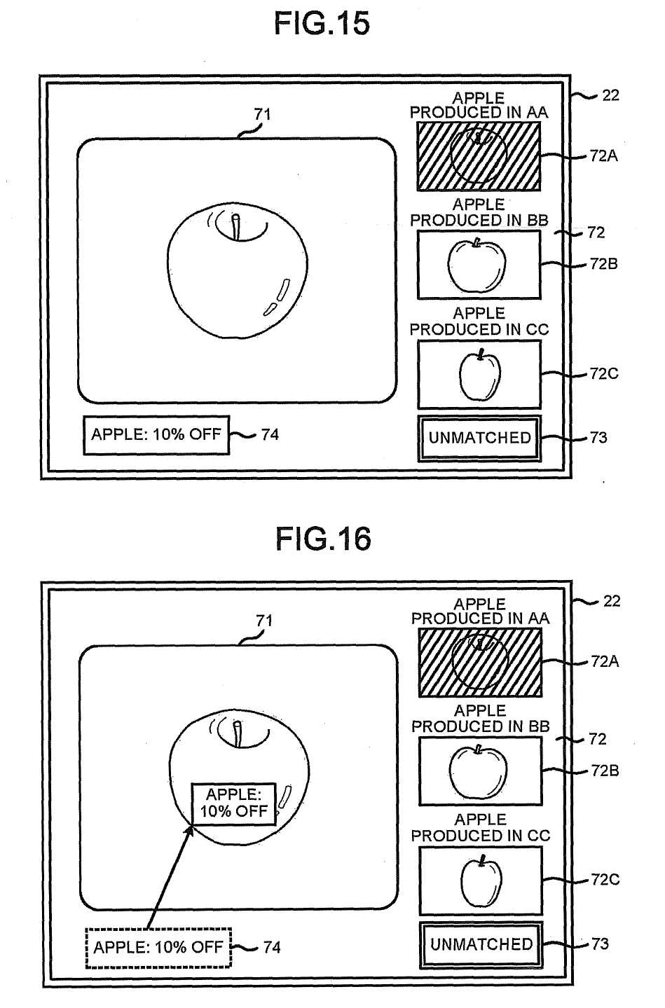

Next, the customer holds the purchased commodity ‘apple’ over the reading window 23. Then, as shown in FIG. 15, the image of the commodity ‘apple’ shot by the camera 62 is displayed in the shot image display area 71 of the display 22 for operator, and images of candidate objects (‘apple produced in AA’, ‘apple produced in BB’ and ‘apple produced in CC’) are displayed in the candidate object display area 72 as touch switches 72A, 72B and 72C.

Here, as shown by the hatching in FIG. 15, if the customer touches the touch switch 72A, the commodity information of the commodity ‘apple produced in AA’ selected through a touch operation and the coupon information stored in the coupon holding memory M1 are output to the sales registration unit 15 through the object recognition unit 14C, the information confirmation unit 14E and the information output unit 14F. As a result, the sales data of the commodity ‘apple produced in AA’ is registered at a discount of 10% in the sales registration unit 15.

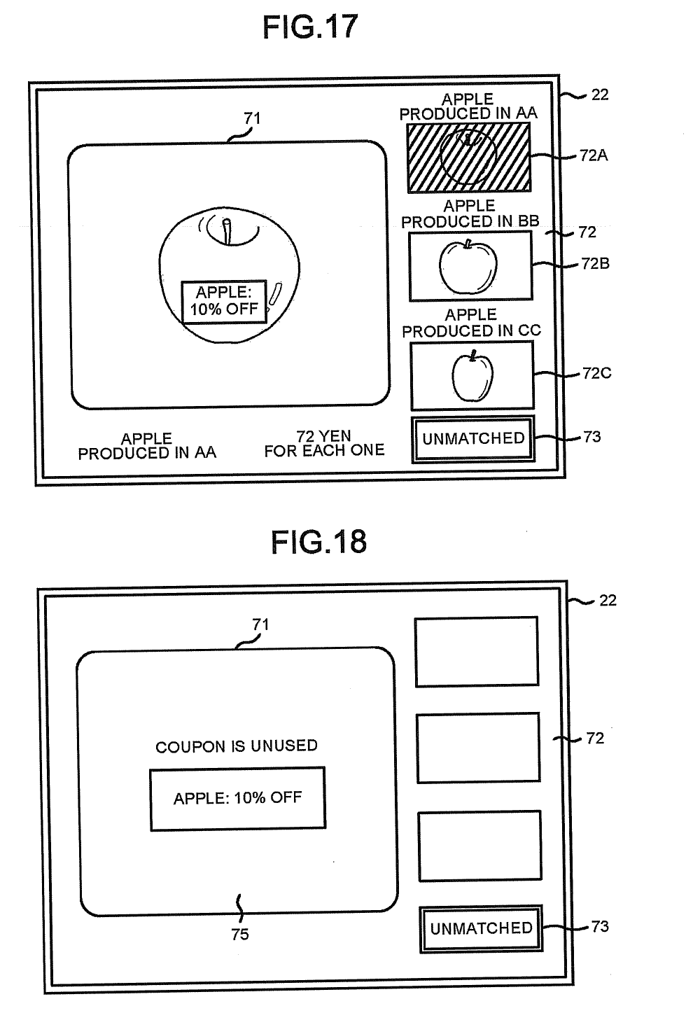

At this time, as shown in FIG. 16, in the display 22 for operator, the image 74 of the used coupon ‘apple: 10% off’ moves into the shot image display area 71, and the image 74 of the coupon ‘apple: 10% off’ on the lower part of the screen is erased. In the self-service POS terminal 1, coupon information is deleted from the coupon holding memory M1 by the information deleting unit 14G. Then, after the coupon information is deleted, as shown in FIG. 17, the commodity name, the sales volume and the selling price of the commodity ‘apple produced in AA’ selling at a discount of 10% based on the coupon ‘apple: 10% off’ are displayed on the lower part of the screen, as shown in FIG. 17.

Further, it is set that the reading window is blocked by another commodity such as ‘banana’ before the customer holds the purchased commodity ‘apple’ over the reading window. The commodity ‘banana’ is not the coupon object of the coupon information of which is stored in the coupon holding memory M1. In this case, the commodity information of the commodity ‘banana’ is separately output to the sales registration unit through the object recognition unit 14C, the information confirmation unit 14E and the information output unit 14F to register the sales data of the commodity ‘banana’. In the case, the coupon information stored in the coupon holding memory M1 is not deleted. The commodity name, the sales volume and the selling price of the commodity ‘banana’ are temporarily displayed on the lower part of the screen of the display 22 for operator, and then the image 74 of the used coupon ‘apple: 10% off’ is returned.

Therefore, if the customer holds the purchased commodity ‘apple’ over the reading window later, the commodity information of the commodity ‘apple produced in AA’ and the coupon information of the coupon ‘apple: 10% off’ are output to the sales registration unit 15, as described in FIG. 15-FIG. 17, so that the sales data of the commodity ‘apple produced in AA’ can be registered at a discount of 10%.

However, sometimes, a coupon held by a customer is recognized as the customer holds the coupon over the reading window 23 while the commodity to which the coupon is applied is not included in the commodities purchased by the customer. For example, in the specific example illustrated in FIG. 13-FIG. 17, a coupon ‘apple: 10% off’ is sometimes recognized from a shot image, however, the checkout button is sequentially touched while the commodity ‘apple’ to which the coupon is applied is not recognized. At this time, in the self-service POS terminal 1, the reading process is ended while the coupon information of the coupon ‘apple: 10% off’ is stored in the coupon holding memory M1. In this case, in the self-service POS terminal 1, a message 75 ‘coupon ‘apple: 10% off’ is not used’ is displayed on the display 22 for operator for the customer through the ending confirmation unit 14I and the unused coupon notification unit 14J, as shown in FIG. 18.

Thus, according to the self-service POS terminal 1 of embodiment 1, the customer can enjoy the benefit offered by a coupon by blocking the reading window 23 with a commodity and the coupon on his/her own.

Further, according to the self-service POS terminal 1 of embodiment 1, as the image 74 of a coupon recognized from a shot image is displayed on the screen of the display 22 for operator before the coupon is used, the customer is easily recognize that the coupon is not used. Further, as a message 75 ‘coupon ‘apple: 10% off’ is not used’ is displayed on the display 22 for operator if an checkout operation is carried out without using the coupon, the customer is easily recognize that a coupon ‘apple: 10% off’ is not used.

### Embodiment 2

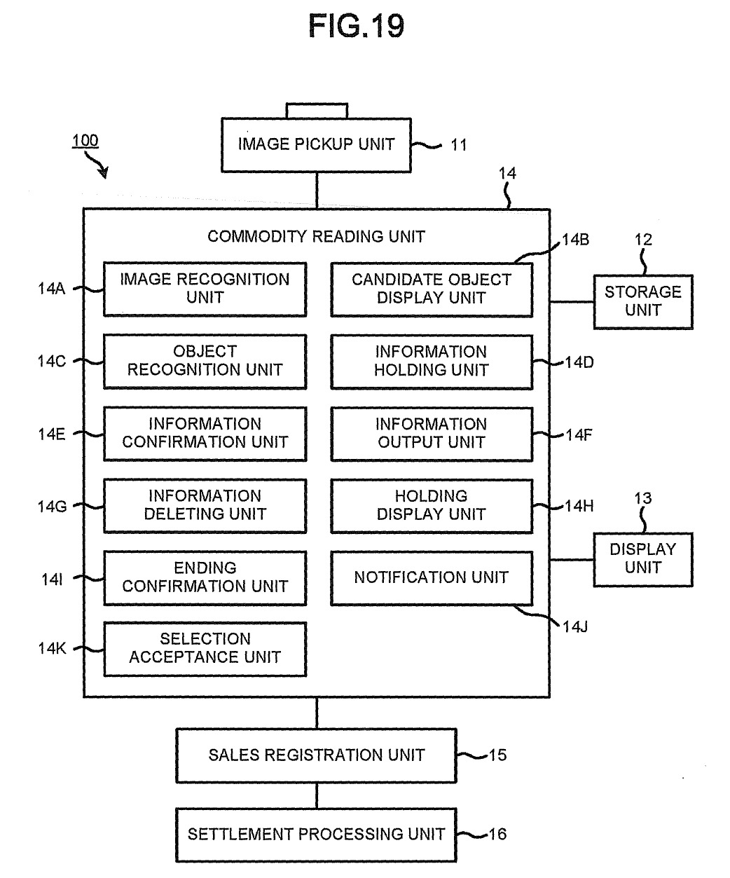

Embodiment 2 is described below with reference to FIG. 19-FIG. 23. The same parts of embodiments 1 and 2 are marked with the same reference symbol and are therefore not described repeatedly here.

FIG. 19 is a functional block diagram of a self-service POS terminal 100 according to embodiment 2. As shown in FIG. 19, the self-service POS terminal 100 comprises an image pickup unit 11, a storage unit 12, a display unit 13, a commodity recognition unit 140, a sales registration unit 15 and a settlement processing unit 16.

In addition to the image recognition unit 14A, the candidate object display unit 14B, the object recognition unit 14C, the information holding unit 14D, the information confirmation unit 14E, the information output unit 14F, the information deleting unit 14G, the holding display unit 14H, the ending confirmation unit 14I and the unused coupon notification unit 14J, the commodity recognition unit 140 further comprises a selection acceptance unit 14K.

The selection acceptance unit 14K accepts, if the information confirmation unit 14E confirms that information relative to a coupon applied to the commodity is stored in the storage unit 12, a selection on whether or not to use a coupon relative to the information. Thus, if the information confirmation unit 14E confirms that information relative to the coupon applied to the commodity is stored in the storage unit 12 and the selection acceptance unit 14K accepts the input of a content ‘use no coupon’, the information output unit 14F only outputs the information relative to the commodity, and if the selection acceptance unit 14K accepts the input of a content ‘use a coupon’, the information output unit 14F outputs the information relative to the commodity and the information relative to the coupon selected to be used.

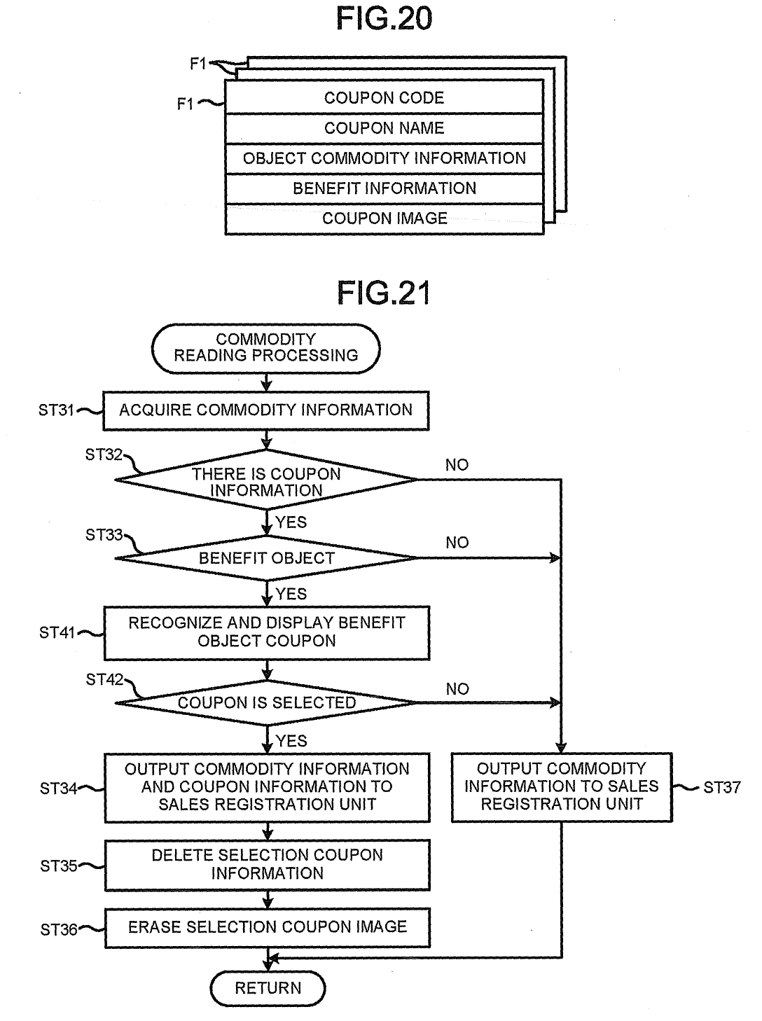

The self-service POS terminal 100 is substantially identical to the self-service POS terminal 1 of embodiment 1 in appearance configuration and hardware configuration. In the self-service POS terminal 1, only one coupon information file F1 is stored in the coupon holding memory M1 formed in the RAM 44, however, in the self-service POS terminal 100, a plurality of coupon information files F1 can be stored in the coupon holding memory M1, as shown in FIG. 20.

Further, in the self-service POS terminal 100, the information processing procedure carried out by the CPU 41 in accordance with the reading processing program P1 is substantially identical to that carried out in the self-service POS terminal 1 of embodiment 1. However, the commodity reading processing realized in ACT ST12 shown in FIG. 8 is partially different in the self-service POS terminal 100 and the self-service POS terminal 1.

FIG. 21 is a flowchart illustrating a commodity reading processing carried out by the CPU 41 in the self-service POS terminal 100, in which a reference symbol the same as that shown in FIG. 10 denotes an ACT the same as that described in embodiment 1.

That is, in embodiment 2, if the object selected from candidate objects is a commodity, the CPU 41 of the self-service POS terminal 100 acquires the commodity code, the attribute, the commodity name, the unit price and the unit weight of the commodity from the commodity database 451 (ST31). Further, the CPU 41 confirms whether or not coupon information is stored in the coupon holding memory M1 (ST32: information confirmation unit 14E), if there is coupon information stored in the coupon holding memory M1 (ST32: YES), the CPU 41 confirms whether or not the commodity corresponding to the commodity information is the coupon benefit object of the coupon information stored in the coupon holding memory M1 (ST33: information confirmation unit 14E).

If there is no coupon information stored in the coupon holding memory M1 (ST32: NO), or although there is coupon information stored in the coupon holding memory M1, the commodity corresponding to the acquired commodity information is not the object to which a coupon corresponding to the coupon is applied (ST33: NO), the CPU 41 only outputs the acquired commodity information to the sales registration unit 15 (ST37: information output unit 14F), as does in embodiment 1.

With respect to this, if there is only one piece of coupon information stored in the coupon holding memory M1 which is corresponding to a coupon applied to a commodity corresponding to the acquired commodity information (ST33: YES), the CPU 41 can distinguish the image of a coupon constituting a coupon benefit object from that of a coupon not constituting a coupon benefit object in coupon images displayed on the display 22 for operator. Then, the CPU 41 waits for a selection on one of the coupons constituting coupon benefit objects (ST42: selection acceptance unit).

Here, if none of the coupons constituting coupon benefit objects is selected (ST42: NO), the CPU 41 only outputs the acquired commodity information to the sales registration unit 15 (ST37: information output unit 14F).

On the contrary, if it is confirmed according to a signal from the touch panel sensor 222 that a coupon constituting a coupon benefit object is selected (ST42: YES), the CPU 41 outputs the acquired commodity information and the information of the selected coupon to the sales registration unit 15 (ST34: information output unit 14F). Then, the CPU 41 deletes the coupon information file F1 of the coupon information selected from the coupon holding memory M1 (ST35: information deleting unit 14G). Moreover, the CPU 41 erases the image of the coupon from the display 22 for operator (ST36) and then returns to ACT ST2 to acquire next image data to attempt to recognize an object.

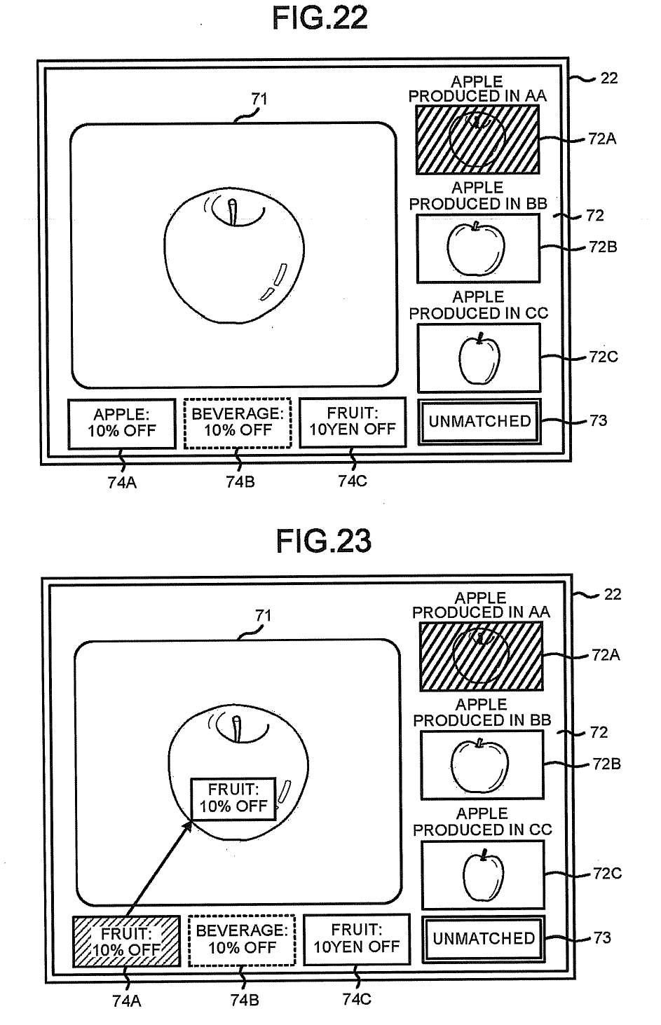

FIG. 22 and FIG. 23 show examples of the display screen of the display 22 for operator on which the reading window 23 is blocked by a purchased commodity ‘apple’ after the self-service POS terminal 100 reads three coupons ‘fruit: 10% off’, ‘beverage: 10% off’ and ‘fruit: 10 Yen off’ that are blocked on the reading window 23. If the customer selects a commodity ‘apple produced in AA’ from candidate commodities of the purchased commodity ‘apple’, the selection acceptance unit 14K mutes, among the images 74A, 74B and 74C of the coupons ‘fruit: 10% off’, ‘beverage: 10% off’ and ‘fruit: 10 Yen off’, the image 74B (shown by the dash line in diagram) of the coupon ‘beverage: 10% off’ not applied to a commodity ‘apple’, as shown in FIG. 22. As a result, images 74A and 74C of the two coupons ‘fruit: 10% off’ and ‘fruit: 10 Yen off’ applied to a commodity ‘apple’ are displayed on the display 22 for operator in a conspicuous manner.

Here, as shown by the hatching in FIG. 23, if the customer touches the image 74A of the coupon ‘fruit: 10% off’, the image 74A of the selected coupon ‘fruit: 10% off’ moves towards the shot image display area 71, and the image 74A of the coupon ‘fruit: 10% off’ displayed on the lower part of the screen is erased. Then, in the self-service POS terminal 1, the commodity information of the commodity ‘apple produced in AA’ and the coupon information of the coupon ‘fruit: 10% off’ stored in the coupon holding memory M1 are registered in the sales registration unit 15 through the information output unit 14F so that the sales data of the commodity ‘apple produced in AA’ is registered at a discount of 10%.

Thus, similarly, according to the self-service POS terminal 100 of embodiment 2, the customer can enjoy a benefit based on a coupon by blocking the reading window 23 with a commodity and the coupon by his/her own.

Moreover, in a case of a plurality of coupons, the customer can block the reading window 23 first with all coupons and then with the purchased commodity, resulting in an excellent effect and a high practicability.

### Embodiment 3

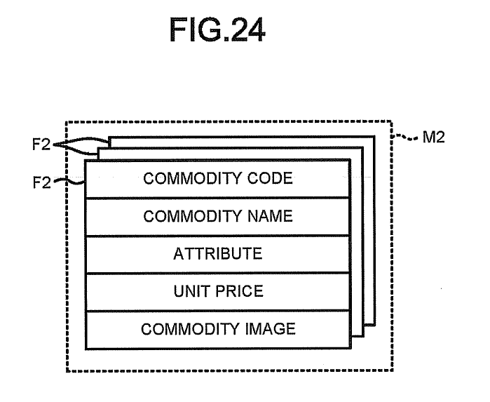

Embodiment 3 is described below with reference to FIG. 24-FIG. 27. The same parts of embodiments 1 and 3 are marked with the same reference symbol and are therefore not described repeatedly here.

It is exemplarily shown in embodiments 1 and 2 that the reading window 23 is blocked first by a coupon and then by a commodity. In embodiment 3, the reading window 23 is first blocked by a commodity and then by a coupon applied to the commodity.

The functional block diagram, the external oblique view and the hardware configuration diagram of a self-service POS terminal 200 (not shown) described in embodiment 3 are the same as those of the self-service POS terminal 1 described in embodiment 1. Thus, FIG. 1 to FIG. 6 are shared.

However, in the self-service POS terminal 200, if a commodity is recognized by the object recognition unit 14C, the information holding unit 14D stores the information relative to the commodity in the storage unit 12 (commodity information holding unit). If the object recognized by the object recognition unit 14C is a coupon, the information confirmation unit 14E confirms whether or not there is information relative to a commodity to which the coupon is applied stored in the storage unit 12 (commodity information confirmation unit). The information deleting unit 14G deletes, if the information output unit 14E outputs information relative to the commodity, the information relative to the commodity from the storage unit 12 (commodity information deleting unit). The holding display unit 14H activates, during the period in which the information relative to the commodity is stored in the storage unit 12, the display unit to display the image of the commodity relative to the information (holding commodity display unit). If the information confirmation unit 14E confirms that the information relative to the commodity to which the coupon is applied is stored in the storage unit 12, the information output unit 14F outputs the information relative to the coupon and the information relative to the commodity to which the coupon is applied. Further, if the ending confirmation unit 14I confirms the end of the reading process while the information relative to the commodity is stored in the storage unit 12, the information output unit 14F only outputs the information relative to the commodity. Further, the unused coupon notification unit 14J is omitted.

In embodiment 1, a coupon holding memory M1 is formed in the RAM 44. In embodiment 3, a commodity holding memory M2 is formed in the RAM 44. As shown in FIG. 24, the commodity holding memory M2 is an area in which a plurality of commodity information files F2 are stored, wherein a commodity code, a commodity name, a unit price and commodity image data are contained in a commodity information file F2.

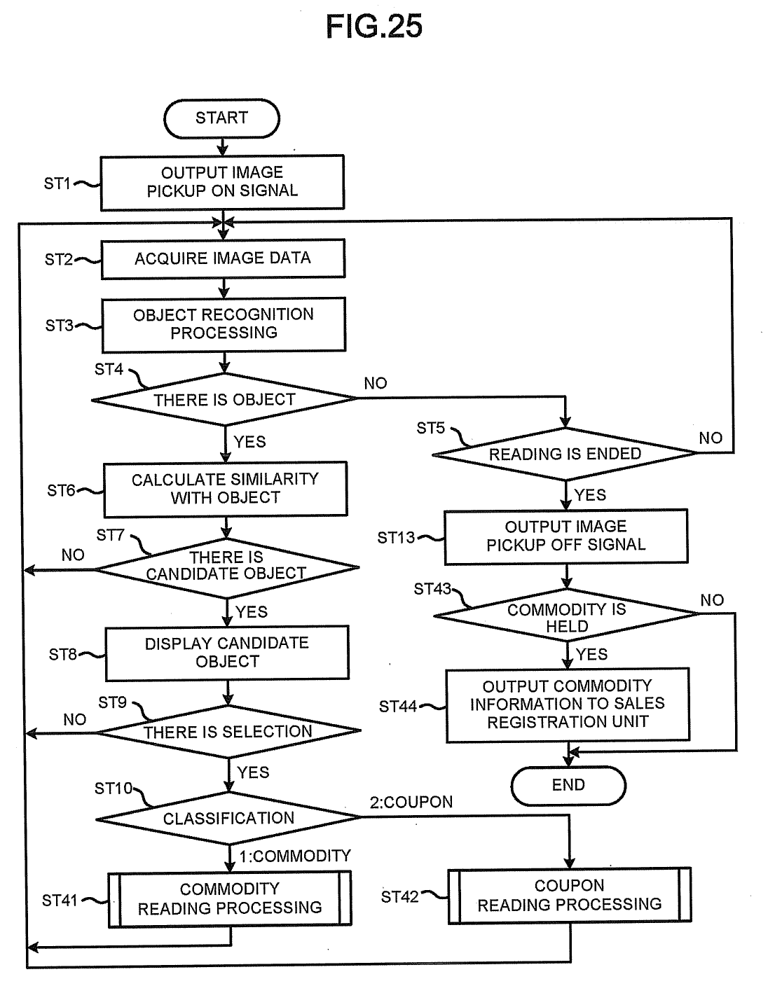

In embodiment 1, the CPU 41 carries out the information processing procedures shown in FIG. 8-FIG. 10 based on the reading processing program P1 installed in the self-service POS terminal 1. In embodiment 3, the CPU 41 carries out the information processing procedures shown in FIG. 25-FIG. 27 based on a reading processing program P1 installed in the self-service POS terminal 200. Functions of the image recognition unit 14A, the candidate object display unit 14B, the object recognition unit 14C, the information holding unit 14D, the information confirmation unit 14E, the information output unit 14F, the information deleting unit 14G, the holding display unit 14H and the ending confirmation unit 14I are described based on the flowcharts.

Much of the information processing illustrated by the ACTs shown in the flowchart of FIG. 25 is the same as the information processing procedure described in embodiment 1 with reference to FIG. 8. The same reference symbol in FIG. 8 and FIG. 25 denotes the same part which is therefore not described repeatedly in embodiment 3.

The information processing procedure described in embodiment 3 is different from that described in embodiment 1 in that the determination processing (object recognition unit 14C) carried out in ACT ST10 is a commodity reading processing (ST41) realized in a case of an object classification ‘1’, that is, the selected object is a commodity, or a coupon reading processing in a case of an object classification ‘2’, that is, the selected object is a coupon (ST 42).

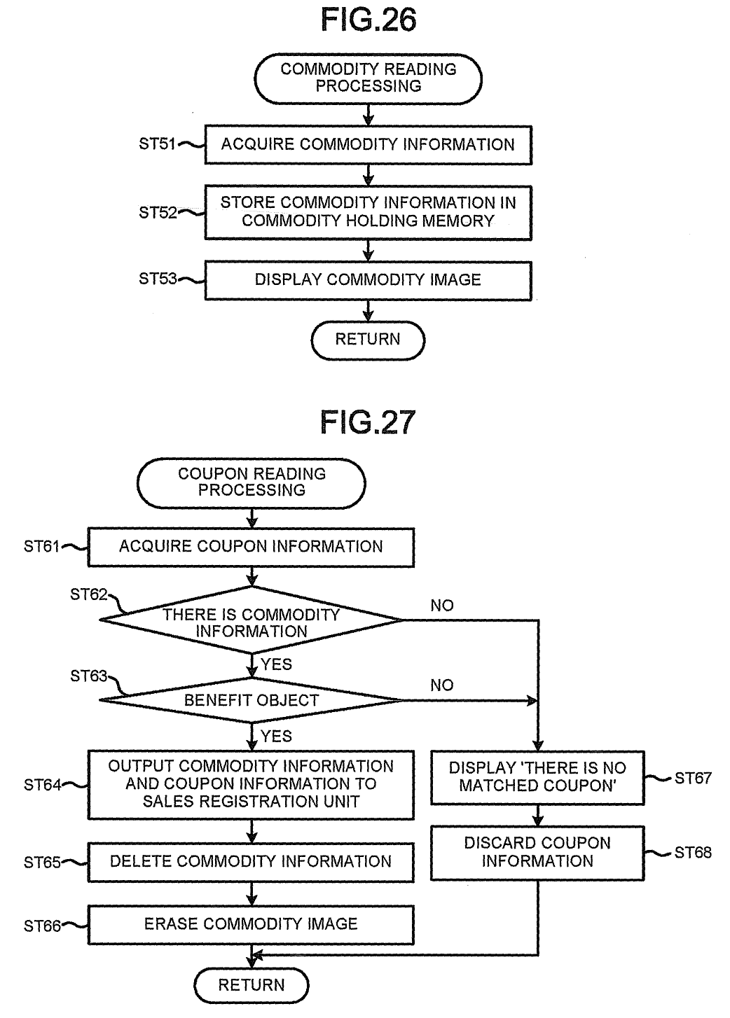

If entering into a commodity reading processing, the CPU 41 starts the processing illustrated by the ACTs shown in the flowchart of FIG. 26. First, the CPU 41 detects the recognition code of an image data record 453R containing the image data of the selected coupon as a commodity code. Then, the CPU 41 retrieves the commodity database 451 using the commodity code to acquire, from a commodity data record 451R containing the commodity code, commodity information including a commodity code, an attribute, a commodity name, a unit price and a unit weight (ST51).

If the CPU 41 acquires the commodity information, then the CPU 41 creates a commodity information file F2 using the commodity information and the image data of the commodity. Then, the CPU 41 stores the commodity information file F2 in the commodity holding memory M2 (ST52: information holding unit 14D). Moreover, the CPU 41 activates the display 22 for operator to display the image of the commodity (ST53: holding display unit 14H). Thereafter, the CPU 41 returns to ACT ST2 to acquire next image data to attempt to recognize an object.

If entering into a coupon reading processing, the CPU 41 starts the processing illustrated by the ACTs shown in the flowchart of FIG. 27. First, the CPU 41 detects the recognition code of an image data record 453R containing the image data of the selected object as a coupon code. Then, the CPU 41 retrieves the coupon database 452 using the coupon code to acquire, from a coupon data record 452R containing the coupon code, coupon information including a coupon code, a coupon name, object commodity information and benefit information (ST61).

If the CPU 41 acquires the coupon information, then the CPU 41 confirms whether or not a commodity information file F2 is stored in the commodity holding memory M2, that is, confirms whether or not there is commodity information stored (ST62: information confirmation unit 14E). If there is commodity information stored in the commodity holding memory M2 (ST62: YES), the CPU 41 reads the commodity information files F2 from the commodity holding memory M2 sequentially. Then, the CPU 41 checks up the commodity code and attribute stored in each read commodity information file F2 with the object commodity information of the coupon information acquired in ACT ST 61. That is, the CPU 41 confirms whether or not the commodity information file F2 of the commodity constituting the benefit object of a coupon corresponding to the coupon information is stored in the commodity holding memory M1 (ST 63: information confirmation unit 14E).

If the CPU 41 confirms that the commodity information file F2 of a commodity constituting the benefit object of the coupon is stored (ST63: YES), the CPU 41 outputs the commodity information contained in the commodity information file F2 and the acquired coupon information to the sales registration unit 15 (ST64: information output unit 14F). Then, the CPU 41 deletes the commodity information file F2 from the commodity holding memory M2 (ST65: information deleting unit 14G). The CPU 41 erases the image of the commodity from the display 22 for operator (ST66). Sequentially, the CPU 41 returns to ACT ST2 to acquire next image data to attempt to recognize an object.

On the other hand, if there is no commodity information file F2 stored in the commodity holding memory M2 (ST62: NO), or although there is coupon information stored in the coupon holding memory M2, the commodity information file F2 is not the commodity information file of the commodity to which a coupon constituting the benefit object of the acquired coupon information is applied (ST63: NO), the CPU 41 activates the display unit 13 to display a message ‘no commodity constituting the object of the coupon’ (ST67). Moreover, the CPU 41 discards the acquired coupon information (ST68).

Further, the information processing carried out in embodiment 3 is different from that carried out in embodiment 1 in that the determination processing of ACT ST5 is carried out after the reading process is announced to be ended. That is, for example, if the checkout button displayed on the display 22 for operator is touched to announce the end of the reading process (ST5: YES), the CPU 41 outputs a image pickup off signal to the camera controller 51 (ST13) and then confirms whether or not a commodity information file F2 is stored in the commodity holding memory M2 (ST 43). If no commodity information file F2 is stored in the commodity holding memory M2 (ST43: NO), the program processing is ended.

If there is a commodity information file F2 stored in the commodity holding memory M2 (ST43: YES), the CPU 41 reads commodity information including a commodity code, a commodity name, an attribute and a unit price from the commodity information file F2 and outputs the read commodity information to the sales registration unit 15 (ST44: information output unit 14F), then the program processing is ended.

The customer using the self-service POS terminal 200 with a related configuration touches the start button first. Then, the customer holds the purchased commodities one after another over the reading window 23. If the customer holds coupons, the customer holds the coupons one after another over the reading window 23.

If the reading window 23 is blocked by a commodity, a commodity information file F2 containing the commodity code and the attribute of the commodity is stored in the commodity holding memory M2. In the case where the reading window 23 is blocked by a coupon, the processing carried out if a commodity information file F2 of the commodity to which the coupon is applied is stored in the commodity holding memory M2 is different from that carried out if no commodity information file F2 is stored in the commodity holding memory M2. If the commodity information file F2 of a commodity to which the coupon is applied is stored in the commodity holding memory M2, the information of the coupon and the information of the commodity to which the coupon is applied are paired and then output to the sales registration unit 15. Then, the commodity information output to the sales registration unit 15 is deleted from the commodity holding memory M2. If the commodity information file F2 of the commodity to which the coupon is applied is not stored in the commodity holding memory M2, the information of the coupon is discarded.

After the reading window 23 is blocked by each commodity and each coupon, the customer touches the checkout button. If the checkout button is touched, if there is a commodity information file F2 remained in the commodity holding memory M2, the commodity information contained in the commodity information file F2 is separately output to the sales registration unit 15.

Thus, according to the self-service POS terminal 200 of embodiment 3, the customer can enjoy a benefit based on a coupon by blocking the reading window 23 with a commodity and the coupon on his/her own, as described in embodiments 1 and 2.

Further, in embodiment 3, if there is no commodity information file F2 stored in the commodity holding memory M2, or although there is a commodity information file F2 stored in the commodity holding memory M2, the commodity information file F2 is not the commodity information file F2 of a commodity to which a coupon constituting the benefit object of a coupon corresponding to the acquired coupon is applied, the CPU 41 discards the acquired coupon information (ST68).

As another embodiment, the CPU 41 may store the coupon information in the coupon holding memory M1 but not discard the coupon information. In this case, if commodity information is acquired by the CPU 41 in the commodity reading processing, then the CPU 41 confirms whether or not the commodity corresponding to the acquired commodity information is the benefit object of the stored benefit information. Then, if the commodity corresponding to the acquired commodity information is the benefit object of the stored benefit information, the commodity information and the coupon information are output to the sales registration unit together, as in embodiment 2. If the commodity corresponding to the acquired commodity information is not the benefit object of the stored benefit information, a commodity information file F2 is created and then stored in the commodity holding memory M2, as in embodiment 3.

In such an embodiment, the coupon information is not discarded even if the reading window 23 is first blocked with a coupon.

### Embodiment 4

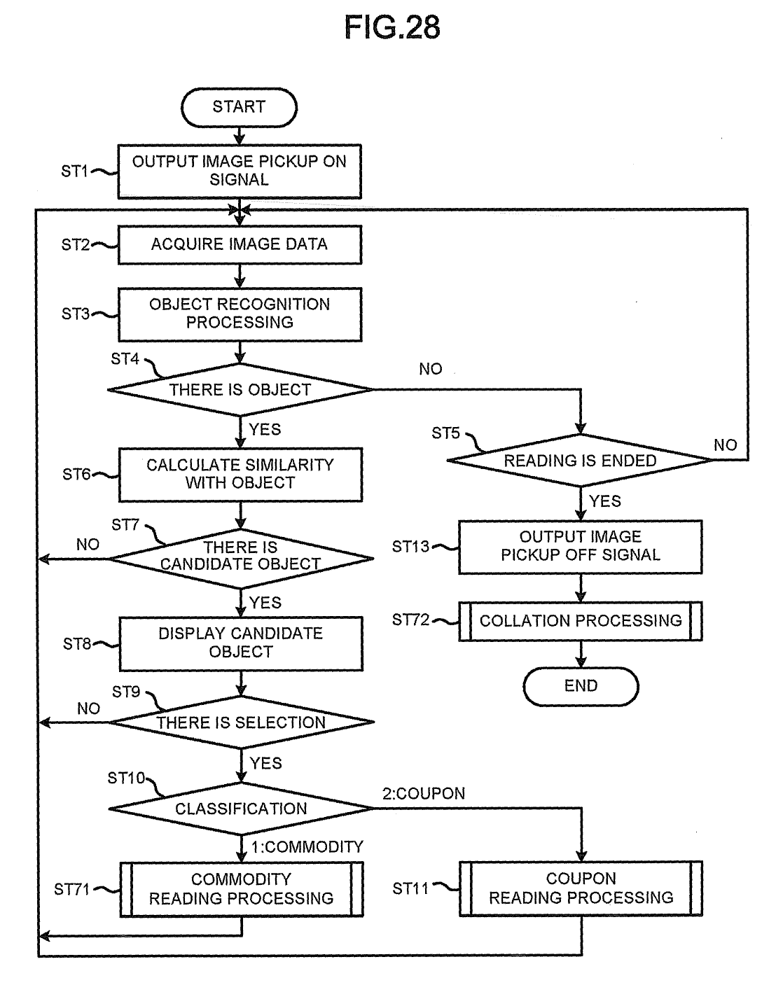

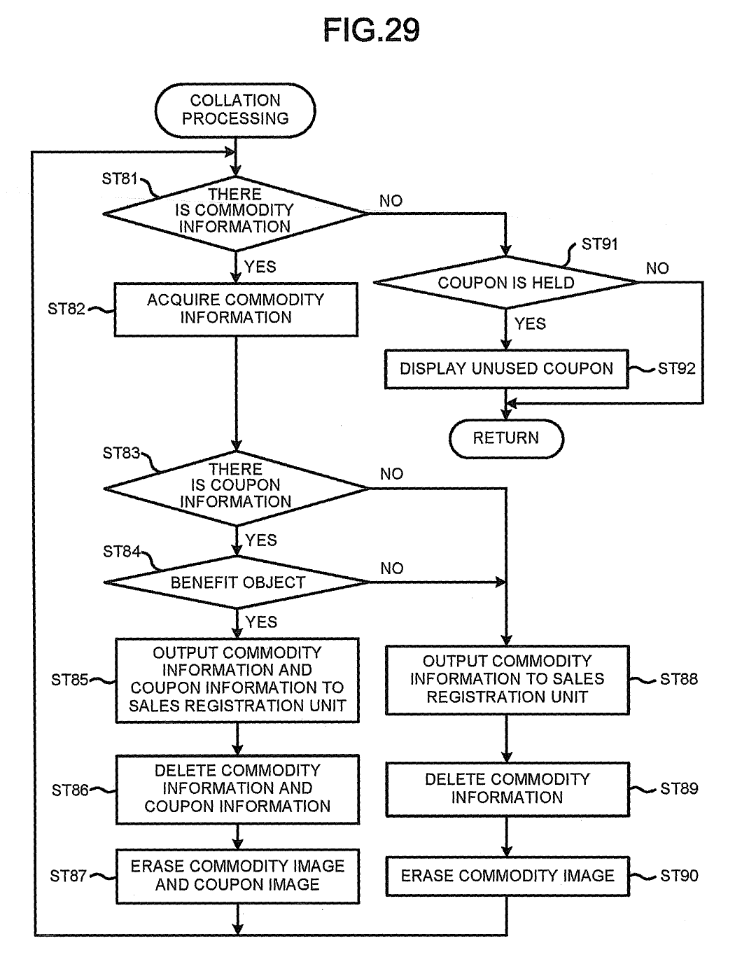

Embodiment 4 is described below with reference to FIG. 28-FIG. 29. The same parts of embodiments 1, 3 and 4 are marked with the same reference symbol and are therefore not described repeatedly here.

In embodiments 1 and 2, the reading window 23 is blocked first by a coupon and then by a commodity. In embodiment 3, the reading window 23 is blocked first by a commodity and then by a coupon. In embodiment 4, no limitation is given to a commodity and a coupon in blocking the reading window 23.

The functional block diagram, the external oblique view and the hardware configuration diagram of a self-service POS terminal 300 (not shown) described in embodiment 4 are the same as those of the self-service POS terminal 1 described in embodiment 1. Thus, FIG. 1-FIG. 6 are shared.

However, the information holding unit 14D comprises: a commodity information holding unit for storing information relative to a commodity that is recognized by the object recognition unit 14C in a first storage unit; and a coupon information holding unit for storing information relative to a coupon that is recognized by the object recognition unit 14D in a second storage unit. If the ending confirmation unit 14I confirms the end of a reading process, the information confirmation unit 14E confirms whether or not information of a coupon applied to a commodity designated by the commodity information stored in the first storage unit is stored in the second storage unit. If information of a coupon applied to a commodity designated by the commodity information stored in the first storage unit is stored in the second storage unit, the information output unit 14F outputs the information relative to the commodity and the information relative to the coupon applied to the commodity, and if information of a coupon applied to a commodity designated by the commodity information stored in the first storage unit is not stored in the second storage unit, the information output unit 14F only outputs the information relative to the commodity.

In embodiment 1, a coupon holding memory M1 is formed in the RAM 44. In embodiment 3, a commodity holding memory M2 is formed in the RAM 44. In embodiment 4, a commodity holding memory M2 (a first storage unit) and a coupon holding memory M1 (a second storage unit) are formed in the RAM 44.

In embodiment 1, the CPU 41 executes the information processing procedure shown in FIG. 8-FIG. 10 based on the reading processing program P1 installed in the self-service POS terminal 1. In embodiment 4, the CPU 41 carries out the information processing procedure shown in FIG. 28-FIG. 29 based on the reading processing program P1. Functions of the image recognition unit 14A, the candidate object display unit 14B, the object recognition unit 14C, the information holding unit 14D, the information confirmation unit 14E, the information output unit 14F, the information deleting unit 14G, the holding display unit 14H, the ending confirmation unit 14I and a notification unit 14J are described based on the flowcharts.

Much of the information processing realized by the ACTs shown in the flowchart of FIG. 28 are the same as the information processing described in embodiment 1 with reference to FIG. 8. Thus, the same reference symbol in FIG. 8 denotes the same process which is therefore not described repeatedly.

The difference of the information processing procedure described in embodiment 4 from that described in embodiment 1 lies in that the determination processing (object recognition unit 14C) carried out in ACT ST10 is a commodity reading processing (ST71) realized in a case of an object classification ‘1’, that is, the selected object is a commodity. Additionally, in a case of the object classification is ‘2’, that is, the selected object is a coupon, the coupon reading processing (ST11) realized in embodiment 4 is the same as that realized in embodiment 1. Thus, the detailed description is omitted with reference to FIG. 9. The commodity reading processing realized in embodiment 4, which is the same as the commodity reading processing realized in embodiment 3 (ST41), can be understood with reference to FIG. 26 and is therefore not described in detail here.

Different from the information processing realized carried out in embodiment 1, the information processing realized in embodiment 4 is a process carried out after the reading process is announced to be ended. If the reading process is announced to be ended (ST5: YES), the CPU 41 outputs an image pickup off signal to the camera controller 51 (ST13) and then carries out the collation processing specifically shown in the flowchart of FIG. 29 (ST72).

If entering into the collation processing, the CPU 4 confirms whether or not a commodity information file F2 is stored in the commodity holding memory M2 (ST81). If a commodity information file F2 is stored in the commodity holding memory M2 (ST81: YES), the CPU 41 acquires commodity information including a commodity code and an attribute from the commodity information file F2 (ST82).

Next, the CPU 41 confirms whether or not a coupon information file F1 is stored in the coupon holding memory M1 (ST83). If coupon information files F1 are stored in the coupon holding memory M1 (ST83: YES), the CPU 41 acquires coupon information including a coupon code, object commodity information and benefit information from all the coupon information files F1. Then, the CPU 41 confirms whether or not the commodity designated by the commodity information acquired in ACT ST82 is the object of the coupon corresponding to the coupon information (ST84: information confirmation unit 14E).

If the commodity is the benefit object of the coupon (ST84: YES), the CPU 41 outputs the commodity information of the commodity and the coupon information of the coupon serving as a benefit object to the sales registration unit 15 (ST85: information output unit 14F). Then, the CPU 41 deletes the commodity information file 2 and the coupon information file F1 output to the sales registration unit from the commodity holding memory M1 and the coupon holding memory M1 (ST86: information deleting unit 14G). Further, the CPU 41 erases images of the commodity and the coupon from the display 22 for operator (ST87). Then, the CPU 4 returns to ACT ST81 TO confirm whether or not a commodity information file F2 is stored in the commodity holding memory M2.

On the other hand, if there is no coupon information stored in the coupon holding memory M1 (ST83: NO), or although there is coupon information stored in the coupon holding memory M1, the coupon information is not information of a coupon applied to the commodity (ST84: NO), the CPU 41 only outputs the commodity information of the commodity to the sales registration unit 15 (ST88: information output unit 14F). Then, the CPU 41 deletes the commodity information file F2 output from the commodity holding memory M2 to the sales registration unit (ST89: information deleting unit 14G). Further, the CPU 41 erases the image of the commodity from the display 22 for operator (ST90). Then, the CPU 4 returns to ACT ST81 TO confirm whether or not a commodity information file F2 is stored in the commodity holding memory M2.

If there is no commodity information file F2 stored in the commodity holding memory M2 (ST81: NO), the CPU 4 confirms whether or not there is a coupon information file F1 stored in the coupon holding memory M1 (ST91). If no coupon information file F1 is stored in the coupon holding memory M1 (ST91: NO), the processing is ended.

On the contrary, if there is coupon information stored in the coupon holding memory M1 (ST91: YES), the CPU 41 activates the display 22 for operator to notify the user of a message ‘there is an unused coupon’ (ST92: unused coupon notification unit 14J), then the processing is ended.

The customer using the self-service POS terminal 300 with a related configuration touches the start button. Then, the customer holds the purchased commodities one after another over the reading window 23. If the customer holds coupons, the customer holds the coupons one after another over the reading window 23.

If the reading window 23 is blocked by a commodity, a commodity information file F2 containing the commodity code and the attributes of the commodity is stored in the commodity holding memory M2. If the reading block 23 is blocked by a coupon, a coupon information file F1 containing the coupon code, object commodity information and benefit information of the coupon is stored in the coupon holding memory M1.

If the reading on a commodity or coupon is ended, the customer touches the checkout button to announce the end of the reading process. If the end of the reading process is announced, the coupon holding memory M1 is retrieved to determine whether or not the information of the coupon applied to the commodity the information of which is stored in the commodity holding memory M2 is stored in the coupon holding memory M1. If the information of the coupon is stored in the coupon holding memory M1, then the information of the commodity and the information of the coupon are paired and then output to the sales registration unit 15. If the information of the coupon is not stored in the coupon holding memory M1, the information of the commodity is output to the sales registration unit separately.

The commodity information file F2 of the commodity information output to the sales registration unit is deleted from the commodity holding memory M2. In the case where all commodity information files F2 are deleted but a coupon information file F1 is remained in the coupon holding memory M1, a message ‘there is an unused coupon’ is displayed on the display 22 for operator for the user.

Thus, according to the self-service POS terminal 300 of embodiment 4, the customer can enjoy a benefit based on a coupon by blocking the reading window 23 with a commodity and the coupon on his/her own, as in embodiments 1-3.

### Embodiment 5

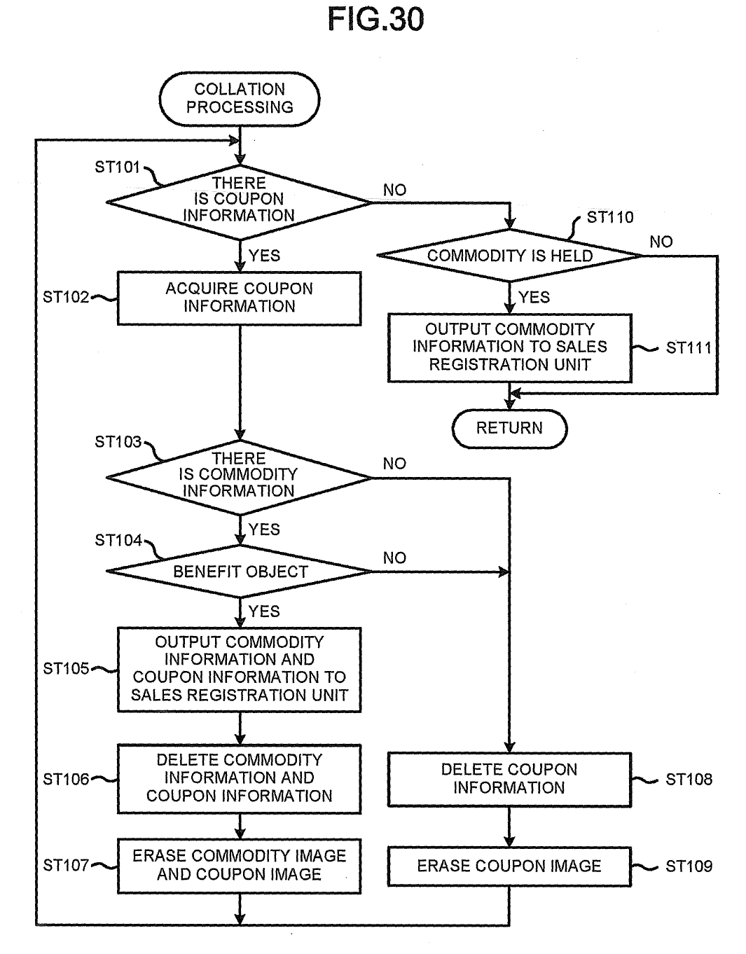

Embodiment 5, an embodiment in which the collation processing shown in FIG. 29 is carried out on the basis of embodiment 4, is described below with reference to FIG. 30. The same parts of embodiments 4 and 5 are marked with the same reference symbol and are therefore not described repeatedly here.

In embodiment 5, if entering into a collation processing, the CPU 41 first confirms whether or not a coupon information file F1 is stored in the coupon holding memory M1 (ST101). If a coupon information file F1 is stored in the coupon holding memory M1 (ST101: YES), the CPU 41 acquires coupon information including a coupon code, object commodity information and benefit information from the coupon information file F1 (ST102).

Next, the CPU 4 confirms whether or not a commodity information file F2 is stored in the commodity holding memory M2 (ST103). If a commodity information file F2 is stored in the commodity holding memory M2 (ST103: YES), the CPU 41 acquires commodity information including a commodity code and an attribute from all the commodity information files F2. Then, the CPU 41 confirms whether or not there is a commodity taking a coupon corresponding to the commodity information acquired in ACT ST102 as a benefit object (ST104: information confirmation unit 14E).

If there is such a commodity (ST104: YES), the CPU 41 outputs the commodity information of the commodity and the coupon information of the coupon constituting a benefit object to the sales registration unit 15 (ST105: information output unit 14F). Then, the CPU 41 deletes the commodity information file 2 and the coupon information file F1 output to the sales registration unit from the commodity holding memory M1 and the coupon holding memory M1 (ST106: information deleting unit 14G). Further, the CPU 41 erases images of the commodity and the coupon from the display 22 for operator (ST107). Then, the CPU 4 returns to ACT ST101 to confirm whether or not a coupon information file F1 is stored in the coupon holding memory M1.

On the other hand, if there is no commodity information stored in the commodity holding memory M2 (ST103: NO), or although there is commodity information stored in the commodity holding memory M2, there is no commodity to which the coupon is applied (ST104: NO), the CPU 41 deletes the coupon information file F1 of the coupon from the coupon holding memory M1 (ST108: information deleting unit 14G). Further, the CPU 41 erases the image of the coupon from the display 22 for operator (ST109). Then, the CPU 41 returns to ACT ST101 to confirm whether or not a coupon information file F1 is stored in the coupon holding memory M1.

If there is no coupon information file F21 stored in the coupon holding memory M1 (ST101: NO), the CPU 41 confirms whether or not there is a commodity information file F2 stored in the commodity holding memory M2 (ST110). If no commodity information file F2 is stored in the commodity holding memory M2 (ST110: NO), the processing is ended.

With respect to this, if there is a commodity information file F2 stored in the commodity holding memory M2, the CPU 41 only outputs the commodity information contained in the commodity information file F2 to the sales registration unit (ST111: information output unit 14F). Then, the processing is ended.

Embodiment 5 having a related configuration can achieve the effect achieved by embodiment 4.

Further, the present invention is not limited to the embodiments above.

For example, in the embodiments above, in the information processing procedure carried out by the CPU 41 in accordance with the reading processing program P1, the objects having a similarity of greater than or equal to the predetermined threshold are selected as candidate objects of the object recognized from the image in the information processing of ACT ST7, and then the images of the candidate objects are displayed (ST8) to wait for a selection on any of the objects (ST9). If an object is selected, a recognition operation is carried out to determine whether the object is a coupon or a commodity (ST10).

In other embodiments in which the selection of the operator on a candidate object is not accepted, an object having an appearance feature parameter having the highest similarity is automatically designated as an object recognized from the image. Then, a recognition operation is carried out to determine whether the designated object is a coupon or a commodity. The present invention is also applicable to such a self-service POS terminal in which the procedure above is carried out, that is, a self-service POS terminal provided with no candidate object display unit 14B.

Further, in the embodiments above, screen examples are shown in FIG. 11-FIG. 18, FIG. 22 and FIG. 23, respectively, however, the layout of the screen is not limited to those. Further, the unused coupon notification unit 14J can also notify an unused coupon through a sound output from a sound synthesizer, but not limited to notify an unused coupon on a display.

Further, the embodiments above are applicable to, but are not limited to, the self-service POS terminals 100, 200 and 300. The image pickup unit 11 and the commodity recognition unit 14 (140) as well as the sales registration unit 15 and the settlement processing unit 16 may be separated from each other. For example, the embodiments above may be applied to a commodity recognition apparatus installed on an accounting counter corresponding to a cashier. To sum up, the embodiments above are applicable to a checkout system provided with a commodity recognition apparatus and a POS terminal. In this case, the commodity database 451, the coupon database 452 and the image database 343 stored in the auxiliary storage unit 45 may be configured at the side of the POS terminal but not at the side of the commodity recognition apparatus.

Further, in the embodiments above, the commodity reading program P1 for realizing the functions of the present invention are pre-recorded in the ROM 43, which is a program storage unit configured in the apparatus. However, the present invention is not limited to this, the same program P1 can also be downloaded to the apparatus from a network. Alternatively, the same program P1 recorded in a recording medium can also be installed in the apparatus. A recording medium in any form that can store programs like a CD-ROM and a memory card and is readable to an apparatus is applicable. Further, the functions achieved by an installed or downloaded program can also be achieved by the cooperation with an OS (Operating System) installed in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity recognition apparatus, comprising:
an image recognition unit configured to recognize an object from an image picked-up by an image pickup unit;
an object recognition unit configured to recognize whether the object recognized by the image recognition unit is a commodity or a coupon; and
an information output unit configured to output, if a commodity recognized by the object recognition unit is the object to which a coupon recognized by the object recognition unit, the information relative to the commodity and the information relative to the coupon applied to the commodity.

2. The commodity recognition apparatus according to claim 1, further comprising:
a coupon information holding unit configured to store the information of a coupon recognized by the object recognition unit in a storage unit; and
a coupon information confirmation unit configured to confirm whether or not information relative to a coupon applied to a commodity recognized by the object recognition unit is stored in the storage unit, wherein
the information output unit outputs, if the coupon information confirmation unit confirms the storage of information relative to a coupon applied to a commodity in the storage unit, the information relative to the commodity and the information relative to the coupon applied to the commodity.

3. The commodity recognition apparatus according to claim 2, further comprising:
a coupon information deleting unit configured to delete, if the information output unit outputs the information relative to the coupon, the information relative to the coupon from the storage unit; and
a holding coupon display unit configured to display the image of the coupon relative to the information on a display during the period in which the information relative to the coupon is stored in the storage unit.

4. The commodity recognition apparatus according to claim 3, further comprising:
a selection acceptance unit configured to accept, if the coupon information confirmation unit confirms that information relative to a coupon applied to the commodity is stored in the storage unit, a selection on whether or not to use a coupon relative to the information, wherein
the information output unit outputs, if the coupon information confirmation unit confirms that information relative to a coupon applied to the commodity is stored in the storage unit and the input of ‘to use a coupon’ is accepted by the selection acceptance unit, the information relative to the commodity and the information relative to the coupon applied to the commodity.

5. The commodity recognition apparatus according to claim 2, further comprising:
an ending confirmation unit configured to confirm whether or not the reading on the commodities settled in one transaction is ended, and
an unused coupon notification unit configured to notify, if the ending confirmation unit confirms the end of the reading, that a coupon relative to the information in the storage unit is not used.

6. The commodity recognition apparatus according to claim 1, further comprising:
a commodity information holding unit configured to store the information of a commodity recognized by the object recognition unit in the storage unit; and
a commodity information confirmation unit configured to confirm whether or not information relative to a commodity that a coupon recognized by the object recognition unit is applied is stored in the storage unit, wherein
the information output unit outputs, if the commodity information confirmation unit confirms that information relative to a commodity that the coupon is applied is stored in the storage unit, the information relative to the coupon and the information relative to the commodity to which the coupon is applied.

7. The commodity recognition apparatus according to claim 6, further comprising:
a commodity information deleting unit configured to delete, if the information output unit outputs the information relative to the commodity, the information relative to the commodity from the storage unit; and
a holding commodity display unit configured to display the image of the commodity relative to the information on a display during the period in which the information relative to the commodity is stored in the storage unit.

8. The commodity recognition apparatus according to claim 7, further comprising:
an ending confirmation unit configured to confirm whether or not the reading on the commodities settled in one transaction is ended, wherein
the information output unit only outputs, if the ending confirmation unit confirms the end of the reading process while the information relative to a commodity is stored in the storage unit, the information relative to the commodity.

9. The commodity recognition apparatus according to claim 1, further comprising:
a commodity information holding unit configured to store the information of a commodity recognized by the object recognition unit in a first storage unit;
a coupon information holding unit configured to store the information of a coupon recognized by the object recognition unit in a second storage unit;
an ending confirmation unit configured to confirm whether or not the reading on the commodities settled in one transaction is ended, and
an information confirmation unit configured to confirm, if the ending confirmation unit confirms the end of the reading process, whether or not the information of a coupon applied to a commodity designated by the commodity information stored in the first storage unit is stored in the second storage unit, wherein
the information output unit outputs the information relative to the commodity and the information relative to the coupon applied to the commodity if the information of a coupon applied to a commodity designated by the commodity information stored in the first storage unit is stored in the second storage unit, and the information output unit only outputs the information relative to the commodity if the information of a coupon applied to a commodity designated by the commodity information stored in the first storage unit is not stored in the second storage unit.

10. The commodity recognition apparatus according to claim 1, further comprising:
a candidate object display unit configured to extract candidate objects similar to the object recognized by the image recognition unit from a group of objects registered in advance and selectively display the candidate objects on the display unit, wherein
the object recognition unit recognizes whether or not the object selected from the candidate objects displayed on the display unit is a commodity or a coupon.

11. A commodity recognition method, comprising:
recognizing an object from an image shot by an image pickup unit;
recognizing whether the object recognized by the image recognition function is a commodity or a coupon; and
outputting, if a commodity recognized by the object recognition function is the object that a coupon recognized by the object recognition function is applied, the information relative to the commodity and the information relative to the coupon applied to the commodity.
